(19) United States
(12) Patent Application Publication
(10) Pub. No.: US 2017/0255875 A1
(43) Pub. Date: Sep. 7, 2017

(54) VALIDATION TERMINATION SYSTEM AND METHODS

(71) Applicant: Pearson Education, Inc., New York, NY (US)

(72) Inventors: Yueh-Mei Chien, Iowa City, IA (US); Seth Daniel Fultz, Cedar Rapids, IA (US); Chingwei David Shin, Iowa City, IA (US); Ning Yan, Taipei (TW)

(21) Appl. No.: 15/059,929

(22) Filed: Mar. 3, 2016

(51) Int. Cl. G06N 99/00; G06N 7/00

(52) U.S. Cl. CPC G06N 99/005; G06N 7/005

(57) ABSTRACT

The present technology relates to systems and methods for termination rules of an assessment or validation based on a history of the validation and a probability that the validation has achieved a valid result. More specifically, the present technology relates to using bootstrap sampling to determine whether a termination rule for an validation is terminating the validation at an appropriate time. Conditions or criteria for termination may include a variety of different parameters, rules or thresholds, such as a termination or cut threshold. The bootstrap termination rule can be one or several values associated with the participant's validation and that can be used to determine when to terminate a validation apart from determining that the participant has passed the validation.

### TECHNICAL FIELD

The present technology relates to systems and methods for termination rules of a validation or assessment based on a history of the validation and a probability that the validation has achieved a valid result. More specifically, the present technology relates to using bootstrap sampling to determine whether a termination rule for an validation is terminating the validation at an appropriate time.

### BACKGROUND

This disclosure relates in general to machine learning. Machine learning is a subfield of computer science that evolved from the study of pattern recognition and computational learning theory in artificial intelligence. Machine learning explores the construction and study of algorithms that can learn from and make predictions on data. Such algorithms operate by building a model from example inputs in order to make data-driven predictions or decisions, rather than following strictly static program instructions.

Machine learning is closely related to and often overlaps with computational statistics; a discipline that also specializes in prediction-making. It has strong ties to mathematical optimization, which deliver methods, theory and application domains to the field. Machine learning is employed in a range of computing tasks where designing and programming explicit, rule-based algorithms is infeasible. Machine learning and pattern recognition can be viewed as two facets of the same field. When employed in industrial contexts, machine learning methods may be referred to as predictive analytics or predictive modelling.

### BRIEF SUMMARY

Embodiments of the present technology are directed to a computer-implemented method. The method may include transmitting, by a server computer, one or more queries to a user, wherein the queries are associated with a validation or assessment of the user; receiving, at the server computer, a data set including data packets associated with a set of user responses to the queries; determining an initial posterior probability based on the data set; determining that the initial posterior probability exceeds a predetermined threshold posterior probability; determining a current length of the assessment based on the one or more queries transmitted to the user; determining that the current length of the assessment exceeds a minimum assessment length; based on determining that the initial posterior probability exceeds a predetermined threshold posterior probability and that the current length of the assessment exceeds a minimum assessment length, determining a first sample of the data set, wherein the first sample of the data set includes data packets associated with the user responses to the queries after a first one of the user responses is removed from the set of user responses; determining a first posterior probability of the first sample of the data set; determining a second sample of the data set, wherein the second sample of the data set includes data packets associated with the user responses to the queries after a second one of the user responses is removed from the set of user responses; determining a second posterior probability of the second sample of the data set; determining a standard error of estimates for the data set based on the first posterior probability of the first sample and the second posterior probability of the second sample; determining that the determined standard error of estimates is less than a predetermined standard error of estimates threshold, wherein the standard error of estimates indicates a confidence in the initial posterior probability for the user; and terminating the assessment of the user based on determining that the determined standard error of estimates is less than the predetermined standard error of estimates threshold.

In alternative aspects, the first one of the user responses removed from the set of user responses and the second one of the user responses removed from the set of user responses are different user responses. In alternative aspects the first one of the user responses is replaced to the set of user responses before the second one of the user responses is removed from the set of user responses. In alternative aspects terminating the assessment of the user includes determining a diagnostic classification model associated with the user based on the data set. In alternative aspects, the method further includes transmitting a communication to the user, wherein the communication includes an assessment score or an attribute status. In alternative aspects, the method further includes determining a maximum assessment length; and determining that the current length of the assessment is less than the maximum assessment length; wherein determining the first sample of the data set is also based on determining that the current length of the assessment is less than the maximum assessment length. In alternative aspects, the method further includes determining a profile probability, wherein the profile probability is determined based on the first posterior probability of the second sample of the data set and the second posterior probability of the second sample of the data set. In alternative aspects, the profile probability is a combined posterior probability associated with an attribute profile of the user.

Alternative embodiments of the present technology are directed to a computing device, comprising one or more processors, a wireless transceiver communicatively coupled to the one or more processors, and a non-transitory computer readable storage medium communicatively coupled to the one or more processors, wherein the non-transitory computer readable storage medium includes instructions that, when executed by the one or more processors, cause the one or more processors to perform operations. The operations may include transmitting, by a server computer, one or more queries to a user, wherein the queries are associated with a validation or assessment of the user; receiving, at the server computer, a data set including data packets associated with a set of user responses to the queries; determining an initial posterior probability based on the data set; determining that the initial posterior probability exceeds a predetermined threshold posterior probability; determining a current length of the assessment based on the one or more queries transmitted to the user; determining that the current length of the assessment exceeds a minimum assessment length; based on determining that the initial posterior probability exceeds a predetermined threshold posterior probability and that the current length of the assessment exceeds a minimum assessment length, determining a first sample of the data set, wherein the first sample of the data set includes data packets associated with the user responses to the queries after a first one of the user responses is removed from the set of user responses; determining a first posterior probability of the first sample of the data set; determining a second sample of the data set, wherein the second sample of the data set includes data packets associated with the user responses to the queries after a second one of the user responses is removed from the set of user responses; determining a second posterior probability of the second sample of the data set; determining a standard error of estimates for the data set based on the first posterior probability of the first sample and the second posterior probability of the second sample; determining that the determined standard error of estimates is less than a predetermined standard error of estimates threshold, wherein the standard error of estimates indicates a confidence in the initial posterior probability for the user; and terminating the assessment of the user based on determining that the determined standard error of estimates is less than the predetermined standard error of estimates threshold.

In alternative aspects, the first one of the user responses removed from the set of user responses and the second one of the user responses removed from the set of user responses are different user responses. In alternative aspects the first one of the user responses is replaced to the set of user responses before the second one of the user responses is removed from the set of user responses. In alternative aspects terminating the assessment of the user includes determining a diagnostic classification model associated with the user based on the data set. In alternative aspects, the operations further include transmitting a communication to the user, wherein the communication includes an assessment score or an attribute status. In alternative aspects, the operations further include determining a maximum assessment length; and determining that the current length of the assessment is less than the maximum assessment length; wherein determining the first sample of the data set is also based on determining that the current length of the assessment is less than the maximum assessment length. In alternative aspects, the operations further include determining a profile probability, wherein the profile probability is determined based on the first posterior probability of the second sample of the data set and the second posterior probability of the second sample of the data set. In alternative aspects, the profile probability is a combined posterior probability associated with an attribute profile of the user.

Alternative embodiments of the present technology are directed to a non-transitory computer readable medium comprising instructions that, when executed by one or more processors, cause the one or more processors to perform operations. The operations may include transmitting, by a server computer, one or more queries to a user, wherein the queries are associated with a validation or assessment of the user; receiving, at the server computer, a data set including data packets associated with a set of user responses to the queries; determining an initial posterior probability based on the data set; determining that the initial posterior probability exceeds a predetermined threshold posterior probability; determining a current length of the assessment based on the one or more queries transmitted to the user; determining that the current length of the assessment exceeds a minimum assessment length; based on determining that the initial posterior probability exceeds a predetermined threshold posterior probability and that the current length of the assessment exceeds a minimum assessment length, determining a first sample of the data set, wherein the first sample of the data set includes data packets associated with the user responses to the queries after a first one of the user responses is removed from the set of user responses; determining a first posterior probability of the first sample of the data set; determining a second sample of the data set, wherein the second sample of the data set includes data packets associated with the user responses to the queries after a second one of the user responses is removed from the set of user responses; determining a second posterior probability of the second sample of the data set; determining a standard error of estimates for the data set based on the first posterior probability of the first sample and the second posterior probability of the second sample; determining that the determined standard error of estimates is less than a predetermined standard error of estimates threshold, wherein the standard error of estimates indicates a confidence in the initial posterior probability for the user; and terminating the assessment of the user based on determining that the determined standard error of estimates is less than the predetermined standard error of estimates threshold.

In alternative aspects, the first one of the user responses removed from the set of user responses and the second one of the user responses removed from the set of user responses are different user responses. In alternative aspects the first one of the user responses is replaced to the set of user responses before the second one of the user responses is removed from the set of user responses. In alternative aspects terminating the assessment of the user includes determining a diagnostic classification model associated with the user based on the data set. In alternative aspects, the operations further include transmitting a communication to the user, wherein the communication includes an assessment score or an attribute status. In alternative aspects, the operations further include determining a maximum assessment length; and determining that the current length of the assessment is less than the maximum assessment length; wherein determining the first sample of the data set is also based on determining that the current length of the assessment is less than the maximum assessment length. In alternative aspects, the operations further include determining a profile probability, wherein the profile probability is determined based on the first posterior probability of the second sample of the data set and the second posterior probability of the second sample of the data set. In alternative aspects, the profile probability is a combined posterior probability associated with an attribute profile of the user.

### BRIEF DESCRIPTION OF THE DRAWINGS

FIG. 1 is a block diagram showing illustrating an example of a content distribution network.

FIG. 2 is a block diagram illustrating a computer server and computing environment within a content distribution network.

FIG. 3 is a block diagram illustrating an embodiment of one or more data store servers within a content distribution network.

FIG. 4A is a block diagram illustrating an embodiment of one or more content management servers within a content distribution network.

FIG. 4B is a flowchart illustrating one embodiment of a process for data management.

FIG. 4C is a flowchart illustrating one embodiment of a process for evaluating a response.

FIG. 5 is a block diagram illustrating the physical and logical components of a special-purpose computer device within a content distribution network.

FIG. 6 is a block diagram illustrating one embodiment of the communication network.

FIG. 7 is a block diagram illustrating one embodiment of user device and supervisor device communication.

FIG. 8A shows a table including raw data associated with example queries and the user's responses to the queries for each answer, according to embodiments of the present technology.

FIG. 8B shows a table including posterior probability data associated with example queries and data associated with additional termination conditions, according to embodiments of the present technology.

FIG. 9 is a flow chart of an example process used to process content items and terminate an assessment based on an adaptive diagnostic assessment approach, according to embodiments of the present technology.

FIG. 10 shows a table including ten iterations of sampling as applied to data associated with example queries and corresponding responses, according to embodiments of the present technology.

FIG. 11 shows a graph with four plots representing user profile attributes, according to embodiments of the present technology.

FIG. 12 shows a graph with four plots representing user profile attributes, according to embodiments of the present technology.

FIG. 13 shows a graph with four plots representing user profile attributes, according to embodiments of the present technology.

FIG. 14 is a flow chart of an example process used to process content items and terminate an assessment based on a termination rule with sampling, according to embodiments of the present technology

FIGS. 15A-15B are a flow chart of an example process used to process content items and terminate an assessment based on a termination rule with sampling, according to embodiments of the present technology.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides illustrative embodiment(s) only and is not intended to limit the scope, applicability or configuration of the disclosure. Rather, the ensuing description of the illustrative embodiment(s) will provide those skilled in the art with an enabling description for implementing a preferred exemplary embodiment. It is understood that various changes can be made in the function and arrangement of elements without departing from the spirit and scope as set forth in the appended claims.

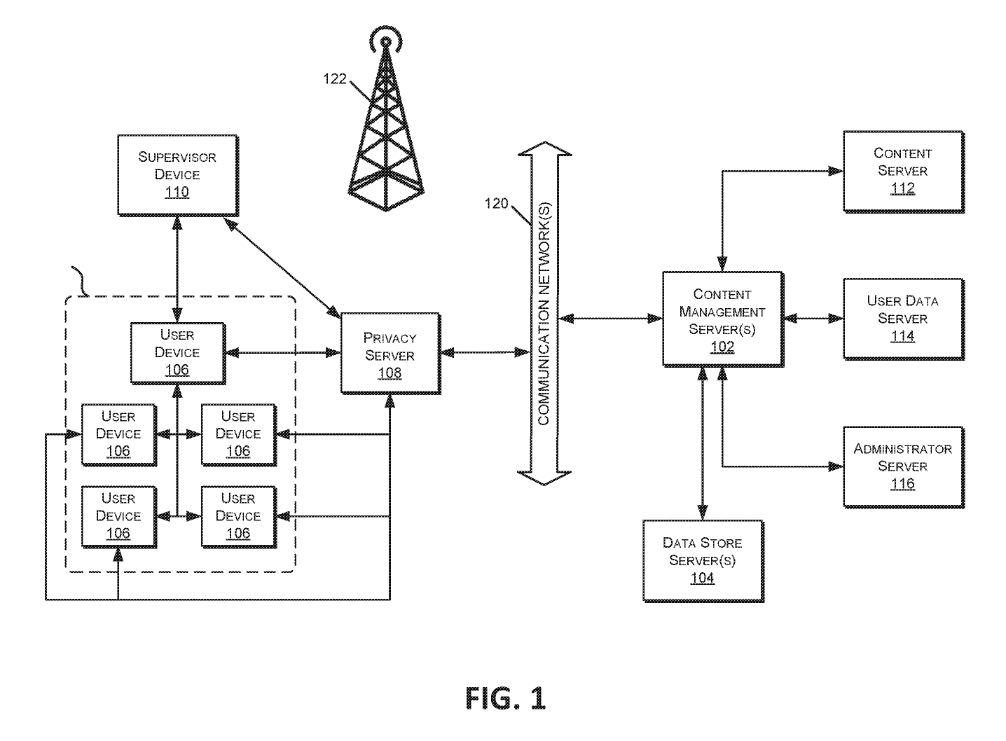

With reference now to FIG. 1, a block diagram is shown illustrating various components of a content distribution network (CDN) 100 which implements and supports certain embodiments and features described herein. Content distribution network 100 may include one or more content management servers 102. As discussed below in more detail, content management servers 102 may be any desired type of server including, for example, a rack server, a tower server, a miniature server, a blade server, a mini rack server, a mobile server, an ultra-dense server, a super server, or the like, and may include various hardware components, for example, a motherboard, a processing units, memory systems, hard drives, network interfaces, power supplies, etc. Content management server 102 may include one or more server farms, clusters, or any other appropriate arrangement and/or combination or computer servers. Content management server 102 may act according to stored instructions located in a memory subsystem of the server 102, and may run an operating system, including any commercially available server operating system and/or any other operating systems discussed herein.

The content distribution network 100 may include one or more data store servers 104, such as database servers and file-based storage systems. The database servers 104 can access data that can be stored on a variety of hardware components. These hardware components can include, for example, components forming tier 0 storage, components forming tier 1 storage, components forming tier 2 storage, and/or any other tier of storage. In some embodiments, tier 0 storage refers to storage that is the fastest tier of storage in the database server 104, and particularly, the tier 0 storage is the fastest storage that is not RAM or cache memory. In some embodiments, the tier 0 memory can be embodied in solid state memory such as, for example, a solid-state drive (SSD) and/or flash memory.

In some embodiments, the tier 1 storage refers to storage that is one or several higher performing systems in the memory management system, and that is relatively slower than tier 0 memory, and relatively faster than other tiers of memory. The tier 1 memory can be one or several hard disks that can be, for example, high-performance hard disks. These hard disks can be one or both of physically or communicatingly connected such as, for example, by one or several fiber channels. In some embodiments, the one or several disks can be arranged into a disk storage system, and specifically can be arranged into an enterprise class disk storage system. The disk storage system can include any desired level of redundancy to protect data stored therein, and in one embodiment, the disk storage system can be made with grid architecture that creates parallelism for uniform allocation of system resources and balanced data distribution.

In some embodiments, the tier 2 storage refers to storage that includes one or several relatively lower performing systems in the memory management system, as compared to the tier 1 and tier 2 storages. Thus, tier 2 memory is relatively slower than tier 1 and tier 0 memories. Tier 2 memory can include one or several SATA-drives or one or several NL-SATA drives.

In some embodiments, the one or several hardware and/or software components of the database server 104 can be arranged into one or several storage area networks (SAN), which one or several storage area networks can be one or several dedicated networks that provide access to data storage, and particularly that provides access to consolidated, block level data storage. A SAN typically has its own network of storage devices that are generally not accessible through the local area network (LAN) by other devices. The SAN allows access to these devices in a manner such that these devices appear to be locally attached to the user device.

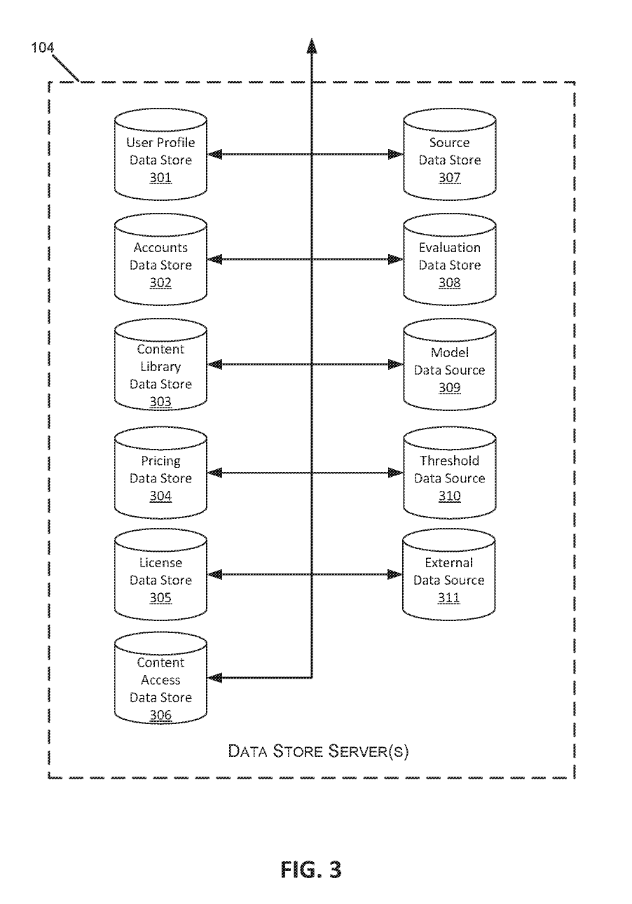

Data stores 104 may comprise stored data relevant to the functions of the content distribution network 100. Illustrative examples of data stores 104 that may be maintained in certain embodiments of the content distribution network 100 are described below in reference to FIG. 3. In some embodiments, multiple data stores may reside on a single server 104, either using the same storage components of server 104 or using different physical storage components to assure data security and integrity between data stores. In other embodiments, each data store may have a separate dedicated data store server 104.

Content distribution network 100 also may include one or more user devices 106 and/or supervisor devices 110. User devices 106 and supervisor devices 110 may display content received via the content distribution network 100, and may support various types of user interactions with the content. User devices 106 and supervisor devices 110 may include mobile devices such as smartphones, tablet computers, personal digital assistants, and wearable computing devices. Such mobile devices may run a variety of mobile operating systems, and may be enabled for Internet, e-mail, short message service (SMS), Bluetooth®, mobile radio-frequency identification (M-RFID), and/or other communication protocols. Other user devices 106 and supervisor devices 110 may be general purpose personal computers or special-purpose computing devices including, by way of example, personal computers, laptop computers, workstation computers, projection devices, and interactive room display systems. Additionally, user devices 106 and supervisor devices 110 may be any other electronic devices, such as a thin-client computers, an Internet-enabled gaming systems, business or home appliances, and/or a personal messaging devices, capable of communicating over network(s) 120.

In different contexts of content distribution networks 100, user devices 106 and supervisor devices 110 may correspond to different types of specialized devices, for example, student devices and teacher devices in an educational network, employee devices and presentation devices in a company network, different gaming devices in a gaming network, etc. In some embodiments, user devices 106 and supervisor devices 110 may operate in the same physical location 107, such as a classroom or conference room. In such cases, the devices may contain components that support direct communications with other nearby devices, such as a wireless transceivers and wireless communications interfaces, Ethernet sockets or other Local Area Network (LAN) interfaces, etc. In other implementations, the user devices 106 and supervisor devices 110 need not be used at the same location 107, but may be used in remote geographic locations in which each user device 106 and supervisor device 110 may use security features and/or specialized hardware (e.g., hardware-accelerated SSL and HTTPS, WS-Security, firewalls, etc.) to communicate with the content management server 102 and/or other remotely located user devices 106. Additionally, different user devices 106 and supervisor devices 110 may be assigned different designated roles, such as presenter devices, teacher devices, administrator devices, or the like, and in such cases the different devices may be provided with additional hardware and/or software components to provide content and support user capabilities not available to the other devices.

The content distribution network 100 also may include a privacy server 108 that maintains private user information at the privacy server 108 while using applications or services hosted on other servers. For example, the privacy server 108 may be used to maintain private data of a user within one jurisdiction even though the user is accessing an application hosted on a server (e.g., the content management server 102) located outside the jurisdiction. In such cases, the privacy server 108 may intercept communications between a user device 106 or supervisor device 110 and other devices that include private user information. The privacy server 108 may create a token or identifier that does not disclose the private information and may use the token or identifier when communicating with the other servers and systems, instead of using the user's private information.

As illustrated in FIG. 1, the content management server 102 may be in communication with one or more additional servers, such as a content server 112, a user data server 112, and/or an administrator server 116. Each of these servers may include some or all of the same physical and logical components as the content management server(s) 102, and in some cases, the hardware and software components of these servers 112-116 may be incorporated into the content management server(s) 102, rather than being implemented as separate computer servers.

Content server 112 may include hardware and software components to generate, store, and maintain the content resources for distribution to user devices 106 and other devices in the network 100. For example, in content distribution networks 100 used for professional training and educational purposes, content server 112 may include data stores of training materials, presentations, plans, syllabi, reviews, evaluations, interactive programs and simulations, course models, course outlines, and various training interfaces that correspond to different materials and/or different types of user devices 106. In content distribution networks 100 used for media distribution, interactive gaming, and the like, a content server 112 may include media content files such as music, movies, television programming, games, and advertisements.

User data server 114 may include hardware and software components that store and process data for multiple users relating to each user's activities and usage of the content distribution network 100. For example, the content management server 102 may record and track each user's system usage, including their user device 106, content resources accessed, and interactions with other user devices 106. This data may be stored and processed by the user data server 114, to support user tracking and analysis features. For instance, in the professional training and educational contexts, the user data server 114 may store and analyze each user's training materials viewed, presentations attended, courses completed, interactions, evaluation results, and the like. The user data server 114 may also include a repository for user-generated material, such as evaluations and tests completed by users, and documents and assignments prepared by users. In the context of media distribution and interactive gaming, the user data server 114 may store and process resource access data for multiple users (e.g., content titles accessed, access times, data usage amounts, gaming histories, user devices and device types, etc.).

Administrator server 116 may include hardware and software components to initiate various administrative functions at the content management server 102 and other components within the content distribution network 100. For example, the administrator server 116 may monitor device status and performance for the various servers, data stores, and/or user devices 106 in the content distribution network 100. When necessary, the administrator server 116 may add or remove devices from the network 100, and perform device maintenance such as providing software updates to the devices in the network 100. Various administrative tools on the administrator server 116 may allow authorized users to set user access permissions to various content resources, monitor resource usage by users and devices 106, and perform analyses and generate reports on specific network users and/or devices (e.g., resource usage tracking reports, training evaluations, etc.).

The content distribution network 100 may include one or more communication networks 120. Although only a single network 120 is identified in FIG. 1, the content distribution network 100 may include any number of different communication networks between any of the computer servers and devices shown in FIG. 1 and/or other devices described herein. Communication networks 120 may enable communication between the various computing devices, servers, and other components of the content distribution network 100. As discussed below, various implementations of content distribution networks 100 may employ different types of networks 120, for example, computer networks, telecommunications networks, wireless networks, and/or any combination of these and/or other networks.

The content distribution network 100 may include one or several navigation systems or features including, for example, the Global Positioning System (“GPS”), GALILEO, or the like, or location systems or features including, for example, one or several transceivers that can determine location of the one or several components of the content distribution network 100 via, for example, triangulation. All of these are depicted as navigation system 122.

In some embodiments, navigation system 122 can include or several features that can communicate with one or several components of the content distribution network 100 including, for example, with one or several of the user devices 106 and/or with one or several of the supervisor devices 110. In some embodiments, this communication can include the transmission of a signal from the navigation system 122 which signal is received by one or several components of the content distribution network 100 and can be used to determine the location of the one or several components of the content distribution network 100.

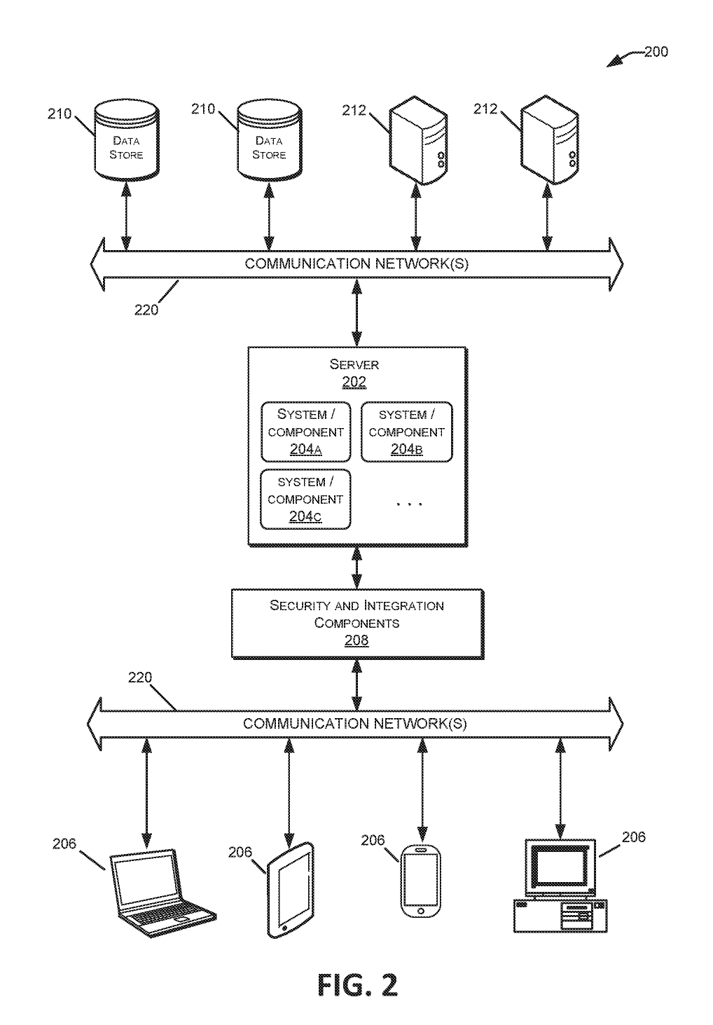

With reference to FIG. 2, an illustrative distributed computing environment 200 is shown including a computer server 202, four client computing devices 206, and other components that may implement certain embodiments and features described herein. In some embodiments, the server 202 may correspond to the content management server 102 discussed above in FIG. 1, and the client computing devices 206 may correspond to the user devices 106. However, the computing environment 200 illustrated in FIG. 2 may correspond to any other combination of devices and servers configured to implement a client-server model or other distributed computing architecture.

Client devices 206 may be configured to receive and execute client applications over one or more networks 220. Such client applications may be web browser based applications and/or standalone software applications, such as mobile device applications. Server 202 may be communicatively coupled with the client devices 206 via one or more communication networks 220. Client devices 206 may receive client applications from server 202 or from other application providers (e.g., public or private application stores). Server 202 may be configured to run one or more server software applications or services, for example, web-based or cloud-based services, to support content distribution and interaction with client devices 206. Users operating client devices 206 may in turn utilize one or more client applications (e.g., virtual client applications) to interact with server 202 to utilize the services provided by these components.

Various different subsystems and/or components 204 may be implemented on server 202. Users operating the client devices 206 may initiate one or more client applications to use services provided by these subsystems and components. The subsystems and components within the server 202 and client devices 206 may be implemented in hardware, firmware, software, or combinations thereof. Various different system configurations are possible in different distributed computing systems 200 and content distribution networks 100. The embodiment shown in FIG. 2 is thus one example of a distributed computing system and is not intended to be limiting.

Although exemplary computing environment 200 is shown with four client computing devices 206, any number of client computing devices may be supported. Other devices, such as specialized sensor devices, etc., may interact with client devices 206 and/or server 202.

As shown in FIG. 2, various security and integration components 208 may be used to send and manage communications between the server 202 and user devices 206 over one or more communication networks 220. The security and integration components 208 may include separate servers, such as web servers and/or authentication servers, and/or specialized networking components, such as firewalls, routers, gateways, load balancers, and the like. In some cases, the security and integration components 208 may correspond to a set of dedicated hardware and/or software operating at the same physical location and under the control of same entities as server 202. For example, components 208 may include one or more dedicated web servers and network hardware in a datacenter or a cloud infrastructure. In other examples, the security and integration components 208 may correspond to separate hardware and software components which may be operated at a separate physical location and/or by a separate entity.

Security and integration components 208 may implement various security features for data transmission and storage, such as authenticating users and restricting access to unknown or unauthorized users. In various implementations, security and integration components 208 may provide, for example, a file-based integration scheme or a service-based integration scheme for transmitting data between the various devices in the content distribution network 100. Security and integration components 208 also may use secure data transmission protocols and/or encryption for data transfers, for example, File Transfer Protocol (FTP), Secure File Transfer Protocol (SFTP), and/or Pretty Good Privacy (PGP) encryption.

In some embodiments, one or more web services may be implemented within the security and integration components 208 and/or elsewhere within the content distribution network 100. Such web services, including cross-domain and/or cross-platform web services, may be developed for enterprise use in accordance with various web service standards, such as RESTful web services (i.e., services based on the Representation State Transfer (REST) architectural style and constraints), and/or web services designed in accordance with the Web Service Interoperability (WS-I) guidelines. Some web services may use the Secure Sockets Layer (SSL) or Transport Layer Security (TLS) protocol to provide secure connections between the server 202 and user devices 206. SSL or TLS may use HTTP or HTTPS to provide authentication and confidentiality. In other examples, web services may be implemented using REST over HTTPS with the OAuth open standard for authentication, or using the WS-Security standard which provides for secure SOAP messages using XML encryption. In other examples, the security and integration components 208 may include specialized hardware for providing secure web services. For example, security and integration components 208 may include secure network appliances having built-in features such as hardware-accelerated SSL and HTTPS, WS-Security, and firewalls. Such specialized hardware may be installed and configured in front of any web servers, so that any external devices may communicate directly with the specialized hardware.

Communication network(s) 220 may be any type of network familiar to those skilled in the art that can support data communications using any of a variety of commercially-available protocols, including without limitation, TCP/IP (transmission control protocol/Internet protocol), SNA (systems network architecture), IPX (Internet packet exchange), Secure Sockets Layer (SSL) or Transport Layer Security (TLS) protocols, Hyper Text Transfer Protocol (HTTP) and Secure Hyper Text Transfer Protocol (HTTPS), Bluetooth®, Near Field Communication (NFC), and the like. Merely by way of example, network(s) 220 may be local area networks (LAN), such as one based on Ethernet, Token-Ring and/or the like. Network(s) 220 also may be wide-area networks, such as the Internet. Networks 220 may include telecommunication networks such as a public switched telephone networks (PSTNs), or virtual networks such as an intranet or an extranet. Infrared and wireless networks (e.g., using the Institute of Electrical and Electronics (IEEE) 802.11 protocol suite or other wireless protocols) also may be included in networks 220.

Computing environment 200 also may include one or more data stores 210 and/or back-end servers 212. In certain examples, the data stores 210 may correspond to data store server(s) 104 discussed above in FIG. 1, and back-end servers 212 may correspond to the various back-end servers 112-116. Data stores 210 and servers 212 may reside in the same datacenter or may operate at a remote location from server 202. In some cases, one or more data stores 210 may reside on a non-transitory storage medium within the server 202. Other data stores 210 and back-end servers 212 may be remote from server 202 and configured to communicate with server 202 via one or more networks 220. In certain embodiments, data stores 210 and back-end servers 212 may reside in a storage-area network (SAN), or may use storage-as-a-service (STaaS) architectural model.

With reference to FIG. 3, an illustrative set of data stores and/or data store servers is shown, corresponding to the data store servers 104 of the content distribution network 100 discussed above in FIG. 1. One or more individual data stores 301-311 may reside in storage on a single computer server 104 (or a single server farm or cluster) under the control of a single entity, or may reside on separate servers operated by different entities and/or at remote locations. In some embodiments, data stores 301-311 may be accessed by the content management server 102 and/or other devices and servers within the network 100 (e.g., user devices 106, supervisor devices 110, administrator servers 116, etc.). Access to one or more of the data stores 301-311 may be limited or denied based on the processes, user credentials, and/or devices attempting to interact with the data store.

The paragraphs below describe examples of specific data stores that may be implemented within some embodiments of a content distribution network 100. It should be understood that the below descriptions of data stores 301-311, including their functionality and types of data stored therein, are illustrative and non-limiting. Data stores server architecture, design, and the execution of specific data stores 301-311 may depend on the context, size, and functional requirements of a content distribution network 100. For example, in content distribution systems 100 used for professional training and educational purposes, separate databases or file-based storage systems may be implemented in data store server(s) 104 to store trainee and/or student data, trainer and/or professor data, training module data and content descriptions, training results, evaluation data, and the like. In contrast, in content distribution systems 100 used for media distribution from content providers to subscribers, separate data stores may be implemented in data stores server(s) 104 to store listings of available content titles and descriptions, content title usage statistics, subscriber profiles, account data, payment data, network usage statistics, etc.

A user profile data store 301, also referred to herein as a user profile database 301, may include information relating to the end users within the content distribution network 100. This information may include user characteristics such as the user names, access credentials (e.g., logins and passwords), user preferences, and information relating to any previous user interactions within the content distribution network 100 (e.g., requested content, posted content, content modules completed, training scores or evaluations, other associated users, etc.). In some embodiments, this information can relate to one or several individual end users such as, for example, one or several students, teachers, administrators, or the like, and in some embodiments, this information can relate to one or several institutional end users such as, for example, one or several schools, groups of schools such as one or several school districts, one or several colleges, one or several universities, one or several training providers, or the like. In some embodiments, this information can identify one or several user memberships in one or several groups such as, for example, a student's membership in a university, school, program, grade, course, class, or the like.

In some embodiments, the user profile database 301 can include information relating to a user's status, location, or the like. This information can identify, for example, a device a user is using, the location of that device, or the like. In some embodiments, this information can be generated based on any location detection technology including, for example, a navigation system 122, or the like.

Information relating to the user's status can identify, for example, logged-in status information that can indicate whether the user is presently logged-in to the content distribution network 100 and/or whether the log-in-is active. In some embodiments, the information relating to the user's status can identify whether the user is currently accessing content and/or participating in an activity from the content distribution network 100.

In some embodiments, information relating to the user's status can identify, for example, one or several attributes of the user's interaction with the content distribution network 100, and/or content distributed by the content distribution network 100. This can include data identifying the user's interactions with the content distribution network 100, the content consumed by the user through the content distribution network 100, or the like. In some embodiments, this can include data identifying the type of information accessed through the content distribution network 100 and/or the type of activity performed by the user via the content distribution network 100, the lapsed time since the last time the user accessed content and/or participated in an activity from the content distribution network 100, or the like. In some embodiments, this information can relate to a content program comprising an aggregate of data, content, and/or activities, and can identify, for example, progress through the content program, or through the aggregate of data, content, and/or activities forming the content program. In some embodiments, this information can track, for example, the amount of time since participation in and/or completion of one or several types of activities, the amount of time since communication with one or several supervisors and/or supervisor devices 110, or the like.

In some embodiments in which the one or several end users are individuals, and specifically are students, the user profile database 301 can further include information relating to these students' academic and/or educational history. This information can identify one or several courses of study that the student has initiated, completed, and/or partially completed, as well as grades received in those courses of study. In some embodiments, the student's academic and/or educational history can further include information identifying student performance on one or several tests, quizzes, and/or assignments. In some embodiments, this information can be stored in a tier of memory that is not the fastest memory in the content delivery network 100.

The user profile database 301 can include information relating to one or several student learning preferences. In some embodiments, for example, the user, also referred to herein as the student or the student-user may have one or several preferred learning styles, one or several most effective learning styles, and/or the like. In some embodiments, the student's learning style can be any learning style describing how the student best learns or how the student prefers to learn. In one embodiment, these learning styles can include, for example, identification of the student as an auditory learner, as a visual learner, and/or as a tactile learner. In some embodiments, the data identifying one or several student learning styles can include data identifying a learning style based on the student's educational history such as, for example, identifying a student as an auditory learner when the student has received significantly higher grades and/or scores on assignments and/or in courses favorable to auditory learners. In some embodiments, this information can be stored in a tier of memory that is not the fastest memory in the content delivery network 100.

The user profile database 301 can further include information relating to one or several teachers and/or instructors who are responsible for organizing, presenting, and/or managing the presentation of information to the student. In some embodiments, user profile database 301 can include information identifying courses and/or subjects that have been taught by the teacher, data identifying courses and/or subjects currently taught by the teacher, and/or data identifying courses and/or subjects that will be taught by the teacher. In some embodiments, this can include information relating to one or several teaching styles of one or several teachers. In some embodiments, the user profile database 301 can further include information indicating past evaluations and/or evaluation reports received by the teacher. In some embodiments, the user profile database 301 can further include information relating to improvement suggestions received by the teacher, training received by the teacher, continuing education received by the teacher, and/or the like. In some embodiments, this information can be stored in a tier of memory that is not the fastest memory in the content delivery network 100.

An accounts data store 302, also referred to herein as an accounts database 302, may generate and store account data for different users in various roles within the content distribution network 100. For example, accounts may be created in an accounts data store 302 for individual end users, supervisors, administrator users, and entities such as companies or educational institutions. Account data may include account types, current account status, account characteristics, and any parameters, limits, restrictions associated with the accounts.

A content library data store 303, also referred to herein as a content library database 303, may include information describing the individual content items (or content resources or data packets) available via the content distribution network 100. In some embodiments, the library data store 303 may include metadata, properties, and other characteristics associated with the content resources stored in the content server 112. Such data may identify one or more aspects or content attributes of the associated content resources, for example, subject matter, access level, or skill level of the content resources, license attributes of the content resources (e.g., any limitations and/or restrictions on the licensable use and/or distribution of the content resource), price attributes of the content resources (e.g., a price and/or price structure for determining a payment amount for use or distribution of the content resource), rating attributes for the content resources (e.g., data indicating the evaluation or effectiveness of the content resource), and the like. In some embodiments, the library data store 303 may be configured to allow updating of content metadata or properties, and to allow the addition and/or removal of information relating to the content resources. For example, content relationships may be implemented as graph structures, which may be stored in the library data store 303 or in an additional store for use by selection algorithms along with the other metadata.

A pricing data store 304 may include pricing information and/or pricing structures for determining payment amounts for providing access to the content distribution network 100 and/or the individual content resources within the network 100. In some cases, pricing may be determined based on a user's access to the content distribution network 100, for example, a time-based subscription fee, or pricing based on network usage and. In other cases, pricing may be tied to specific content resources. Certain content resources may have associated pricing information, whereas other pricing determinations may be based on the resources accessed, the profiles and/or accounts of the user, and the desired level of access (e.g., duration of access, network speed, etc.). Additionally, the pricing data store 304 may include information relating to compilation pricing for groups of content resources, such as group prices and/or price structures for groupings of resources.

A license data store 305 may include information relating to licenses and/or licensing of the content resources within the content distribution network 100. For example, the license data store 305 may identify licenses and licensing terms for individual content resources and/or compilations of content resources in the content server 112, the rights holders for the content resources, and/or common or large-scale right holder information such as contact information for rights holders of content not included in the content server 112.

A content access data store 306 may include access rights and security information for the content distribution network 100 and specific content resources. For example, the content access data store 306 may include login information (e.g., user identifiers, logins, passwords, etc.) that can be verified during user login attempts to the network 100. The content access data store 306 also may be used to store assigned user roles and/or user levels of access. For example, a user's access level may correspond to the sets of content resources and/or the client or server applications that the user is permitted to access. Certain users may be permitted or denied access to certain applications and resources based on their subscription level, training program, course/grade level, etc. Certain users may have supervisory access over one or more end users, allowing the supervisor to access all or portions of the end user's content, activities, evaluations, etc. Additionally, certain users may have administrative access over some users and/or some applications in the content management network 100, allowing such users to add and remove user accounts, modify user access permissions, perform maintenance updates on software and servers, etc.

A source data store 307 may include information relating to the source of the content resources available via the content distribution network. For example, a source data store 307 may identify the authors and originating devices of content resources, previous pieces of data and/or groups of data originating from the same authors or originating devices, and the like.

An evaluation data store 308 may include information used to direct the evaluation of users and content resources in the content management network 100. In some embodiments, the evaluation data store 308 may contain, for example, the analysis criteria and the analysis guidelines for evaluating users (e.g., trainees/students, gaming users, media content consumers, etc.) and/or for evaluating the content resources in the network 100. The evaluation data store 308 also may include information relating to evaluation processing tasks, for example, the identification of users and user devices 106 that have received certain content resources or accessed certain applications, the status of evaluations or evaluation histories for content resources, users, or applications, and the like. Evaluation criteria may be stored in the evaluation data store 308 including data and/or instructions in the form of one or several electronic rubrics or scoring guides for use in the evaluation of the content, users, or applications. The evaluation data store 308 also may include past evaluations and/or evaluation analyses for users, content, and applications, including relative rankings, characterizations, explanations, and the like.

A model data store 309, also referred to herein as a model database 309 can store information relating to one or several predictive models. In some embodiments, these can include one or several evidence models, risk models, or the like. In some embodiments, an evidence model can be a mathematically-based statistical model. The evidence model can be based on, for example, Item Response Theory (IRT), Bayesian Network (Bayes net), Performance Factor Analysis (PFA), or the like. The evidence model can, in some embodiments, be customizable to a user and/or to one or several content items. Specifically, one or several inputs relating to the user and/or to one or several content items can be inserted into the evidence model. These inputs can include, for example, one or several measures of user skill level, one or several measures of content item difficulty and/or skill level, or the like. The customized evidence model can then be used to predict the likelihood of the user providing desired or undesired responses to one or several of the content items.

In some embodiments, the risk models can include one or several models that can be used to calculate one or several model functions values. In some embodiments, these one or several model function values can be used to calculate a risk probability, which risk probability can characterize the risk of a user such as a student-user failing to achieve a desired outcome such as, for example, failing to achieve a desired level of completion of a program, for example in a pre-defined time period. In some embodiments, the risk probability can identify the risk of the student-user failing to complete 60% of the program.

In some embodiments, these models can include a plurality of model functions including, for example, a first model function, a second model function, a third model function, and a fourth model function. In some embodiments, some or all of the model functions can be associated with a portion of the program such as, for example a completion stage and/or completion status of the program. In one embodiment, for example, the first model function can be associated with a first completion status, the second model function can be associated with a second completion status, the third model function can be associated with a third completion status, and the fourth model function can be associated with a fourth completion status. In some embodiments, these completion statuses can be selected such that some or all of these completion statuses are less than the desired level of completion of the program. Specifically, in some embodiments, these completion status can be selected to all be at less than 60% completion of the program, and more specifically, in some embodiments, the first completion status can be at 20% completion of the program, the second completion status can be at 30% completion of the program, the third completion status can be at 40% completion of the program, and the fourth completion status can be at 50% completion of the program. Similarly, any desired number of model functions can be associated with any desired number of completion statuses.

In some embodiments, a model function can be selected from the plurality of model functions based on a student-user's progress through a program. In some embodiments, the student-user's progress can be compared to one or several status trigger thresholds, each of which status trigger thresholds can be associated with one or more of the model functions. If one of the status triggers is triggered by the student-user's progress, the corresponding one or several model functions can be selected.

The model functions can comprise a variety of types of models and/or functions. In some embodiments, each of the model functions outputs a function value that can be used in calculating a risk probability. This function value can be calculated by performing one or several mathematical operations on one or several values indicative of one or several user attributes and/or user parameters, also referred to herein as program status parameters. In some embodiments, each of the model functions can use the same program status parameters, and in some embodiments, the model functions can use different program status parameters. In some embodiments, the model functions use different program status parameters when at least one of the model functions uses at least one program status parameter that is not used by others of the model functions.

A threshold database 310, also referred to herein as a threshold database, can store one or several threshold values. These one or several threshold values can delineate between states or conditions. In one exemplary embodiments, for example, a threshold value can delineate between an acceptable user performance and an unacceptable user performance, between content appropriate for a user and content that is inappropriate for a user, between risk levels, or the like.

In addition to the illustrative data stores described above, data store server(s) 104 (e.g., database servers, file-based storage servers, etc.) may include one or more external data aggregators 311. External data aggregators 311 may include third-party data sources accessible to the content management network 100, but not maintained by the content management network 100. External data aggregators 311 may include any electronic information source relating to the users, content resources, or applications of the content distribution network 100. For example, external data aggregators 311 may be third-party data stores containing demographic data, education related data, consumer sales data, health related data, and the like. Illustrative external data aggregators 311 may include, for example, social networking web servers, public records data stores, learning management systems, educational institution servers, business servers, consumer sales data stores, medical record data stores, etc. Data retrieved from various external data aggregators 311 may be used to verify and update user account information, suggest user content, and perform user and content evaluations.

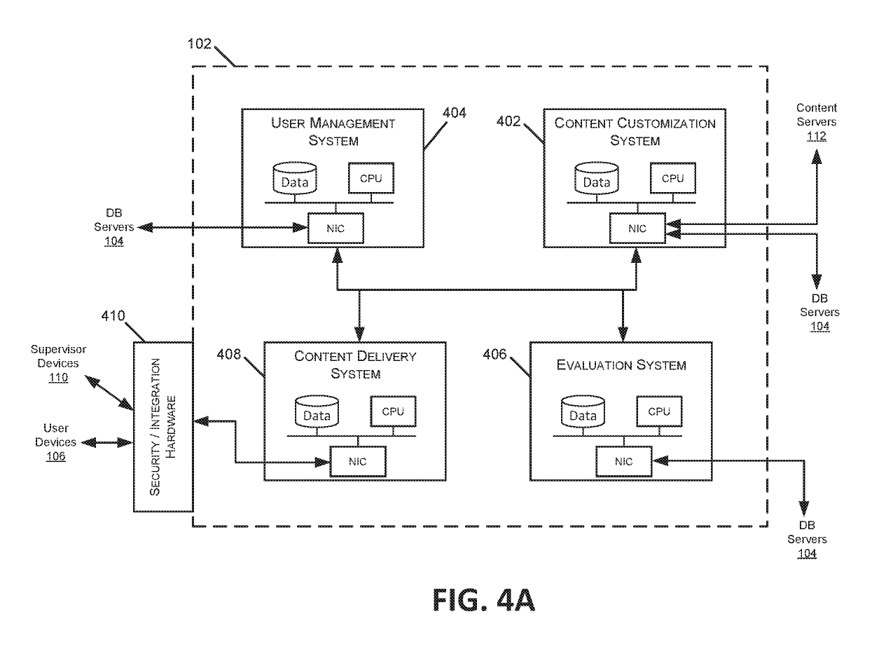

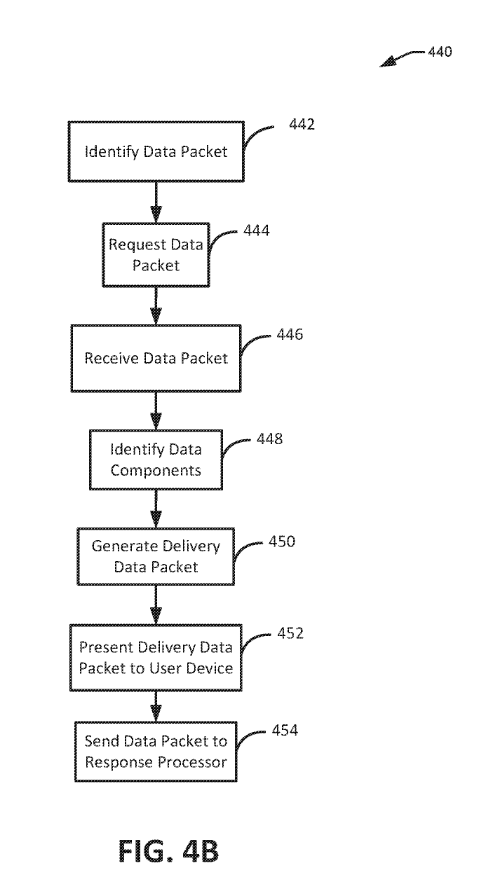

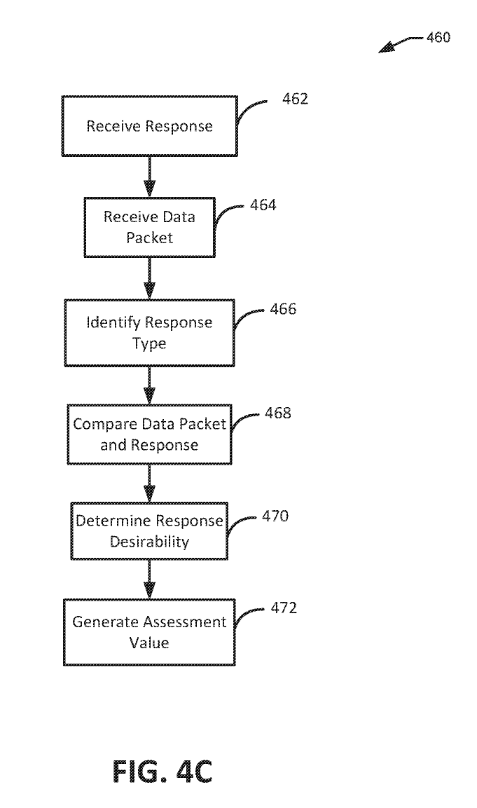

With reference now to FIG. 4A, a block diagram is shown illustrating an embodiment of one or more content management servers 102 within a content distribution network 100. As discussed above, content management server(s) 102 may include various server hardware and software components that manage the content resources within the content distribution network 100 and provide interactive and adaptive content to users on various user devices 106. For example, content management server(s) 102 may provide instructions to and receive information from the other devices within the content distribution network 100, in order to manage and transmit content resources, user data, and server or client applications executing within the network 100.

A content management server 102 may include a content customization system 402. The content customization system 402 may be implemented using dedicated hardware within the content distribution network 100 (e.g., a content customization server 402), or using designated hardware and software resources within a shared content management server 102. In some embodiments, the content customization system 402 may adjust the selection and adaptive capabilities of content resources to match the needs and desires of the users receiving the content. For example, the content customization system 402 may query various data stores and servers 104 to retrieve user information, such as user preferences and characteristics (e.g., from a user profile data store 301), user access restrictions to content recourses (e.g., from a content access data store 306), previous user results and content evaluations (e.g., from an evaluation data store 308), and the like. Based on the retrieved information from data stores 104 and other data sources, the content customization system 402 may modify content resources for individual users.

In some embodiments, the content management system 402 can include a recommendation engine, also referred to herein as an adaptive recommendation engine. In some embodiments, the recommendation engine can select one or several pieces of content, also referred to herein as data packets, for providing to a user. These data packets can be selected based on, for example, the information retrieved from the database server 104 including, for example, the user profile database 301, the content library database 303, the model database 309, or the like. In one embodiment, for example, the recommendation engine can retrieve information from the user profile database 301 identifying, for example, a skill level of the user. The recommendation engine can further retrieve information from the content library database 303 identifying, for example, potential data packets for providing to the user and the difficulty of those data packets and/or the skill level associated with those data packets.

The recommendation engine can use the evidence model to generate a prediction of the likelihood of one or several users providing a desired response to some or all of the potential data packets. In some embodiments, the recommendation engine can pair one or several data packets with selection criteria that may be used to determine which packet should be delivered to a student-user based on one or several received responses from that student-user. In some embodiments, one or several data packets can be eliminated from the pool of potential data packets if the prediction indicates either too high a likelihood of a desired response or too low a likelihood of a desired response. In some embodiments, the recommendation engine can then apply one or several selection criteria to the remaining potential data packets to select a data packet for providing to the user. These one or several selection criteria can be based on, for example, criteria relating to a desired estimated time for receipt of response to the data packet, one or several content parameters, one or several assignment parameters, or the like.

A content management server 102 also may include a user management system 404. The user management system 404 may be implemented using dedicated hardware within the content distribution network 100 (e.g., a user management server 404), or using designated hardware and software resources within a shared content management server 102. In some embodiments, the user management system 404 may monitor the progress of users through various types of content resources and groups, such as media compilations, courses or curriculums in training or educational contexts, interactive gaming environments, and the like. For example, the user management system 404 may query one or more databases and/or data store servers 104 to retrieve user data such as associated content compilations or programs, content completion status, user goals, results, and the like.

A content management server 102 also may include an evaluation system 406, also referred to herein as a response processor. The evaluation system 406 may be implemented using dedicated hardware within the content distribution network 100 (e.g., an evaluation server 406), or using designated hardware and software resources within a shared content management server 102. The evaluation system 406 may be configured to receive and analyze information from user devices 106. For example, various ratings of content resources submitted by users may be compiled and analyzed, and then stored in a data store (e.g., a content library data store 303 and/or evaluation data store 308) associated with the content. In some embodiments, the evaluation server 406 may analyze the information to determine the effectiveness or appropriateness of content resources with, for example, a subject matter, an age group, a skill level, or the like. In some embodiments, the evaluation system 406 may provide updates to the content customization system 402 or the user management system 404, with the attributes of one or more content resources or groups of resources within the network 100. The evaluation system 406 also may receive and analyze user evaluation data from user devices 106, supervisor devices 110, and administrator servers 116, etc. For instance, evaluation system 406 may receive, aggregate, and analyze user evaluation data for different types of users (e.g., end users, supervisors, administrators, etc.) in different contexts (e.g., media consumer ratings, trainee or student comprehension levels, teacher effectiveness levels, gamer skill levels, etc.).

In some embodiments, the evaluation system 406 can be further configured to receive one or several responses from the user and to determine whether the one or several response are correct responses, also referred to herein as desired responses, or are incorrect responses, also referred to herein as undesired responses. In some embodiments, one or several values can be generated by the evaluation system 406 to reflect user performance in responding to the one or several data packets. In some embodiments, these one or several values can comprise one or several scores for one or several responses and/or data packets.

A content management server 102 also may include a content delivery system 408. The content delivery system 408 may be implemented using dedicated hardware within the content distribution network 100 (e.g., a content delivery server 408), or using designated hardware and software resources within a shared content management server 102. The content delivery system 408 can include a presentation engine that can be, for example, a software module running on the content delivery system.

The content delivery system 408, also referred to herein as the presentation module or the presentation engine, may receive content resources from the content customization system 402 and/or from the user management system 404, and provide the resources to user devices 106. The content delivery system 408 may determine the appropriate presentation format for the content resources based on the user characteristics and preferences, and/or the device capabilities of user devices 106. If needed, the content delivery system 408 may convert the content resources to the appropriate presentation format and/or compress the content before transmission. In some embodiments, the content delivery system 408 may also determine the appropriate transmission media and communication protocols for transmission of the content resources.

In some embodiments, the content delivery system 408 may include specialized security and integration hardware 410, along with corresponding software components to implement the appropriate security features content transmission and storage, to provide the supported network and client access models, and to support the performance and scalability requirements of the network 100. The security and integration layer 410 may include some or all of the security and integration components 208 discussed above in FIG. 2, and may control the transmission of content resources and other data, as well as the receipt of requests and content interactions, to and from the user devices 106, supervisor devices 110, administrative servers 116, and other devices in the network 100.

With reference now to FIG. 4B, a flowchart illustrating one embodiment of a process 440 for data management is shown. In some embodiments, the process 440 can be performed by the content management server 102, and more specifically by the content delivery system 408 and/or by the presentation module or presentation engine. The process 440 begins at block 442, wherein a data packet is identified. In some embodiments, the data packet can be a data packet for providing to a student-user, and the data packet can be identified by determining which data packet to next provide to the user such as the student-user. In some embodiments, this determination can be performed by the content customization system 402 and/or the recommendation engine.

After the data packet has been identified, the process 440 proceeds to block 444, wherein the data packet is requested. In some embodiments, this can include the requesting of information relating to the data packet such as the data forming the data packet. In some embodiments, this information can be requested from, for example, the content library database 303. After the data packet has been requested, the process 440 proceeds to block 446, wherein the data packet is received. In some embodiments, the data packet can be received by the content delivery system 408 from, for example, the content library database 303.

After the data packet has been received, the process 440 proceeds to block 448, wherein one or several data components are identified. In some embodiments, for example, the data packet can include one or several data components which can, for example, contain different data. In some embodiments, one of these data components, referred to herein as a presentation component, can include content for providing to the student user, which content can include one or several requests and/or questions and/or the like. In some embodiments, one of these data components, referred to herein as a response component, can include data used in evaluating one or several responses received from the user device 106 in response to the data packet, and specifically in response to the presentation component and/or the one or several requests and/or questions of the presentation component. Thus, in some embodiments, the response component of the data packet can be used to ascertain whether the user has provided a desired response or an undesired response.

After the data components have been identified, the process 440 proceeds to block 450, wherein a delivery data packet is identified. In some embodiments, the delivery data packet can include the one or several data components of the data packets for delivery to a user such as the student-user via the user device 106. In some embodiments, the delivery packet can include the presentation component, and in some embodiments, the delivery packet can exclude the response packet. After the delivery data packet has been generated, the process 440 proceeds to block 452, wherein the delivery data packet is presented to the user device 106. In some embodiments, this can include providing the delivery data packet to the user device 106 via, for example, the communication network 120.

After the delivery data packet has been provided to the user device, the process 440 proceeds to block 454, wherein the data packet and/or one or several components thereof is sent to and/or provided to the response processor. In some embodiments, this sending of the data packet and/or one or several components thereof to the response processor can include receiving a response from the student-user, and sending the response to the student-user to the response processor simultaneous with the sending of the data packet and/or one or several components thereof to the response processor. In some embodiments, for example, this can include providing the response component to the response processor. In some embodiments, the response component can be provided to the response processor from the content delivery system 408.

With reference now to FIG. 4C, a flowchart illustrating one embodiment of a process 460 for evaluating a response is shown. In some embodiments, the process can be performed by the evaluation system 406. In some embodiments, the process 460 can be performed by the evaluation system 406 in response to the receipt of a response from the user device 106.

The process 460 begins at block 462, wherein a response is received from, for example, the user device 106 via, for example, the communication network 120. After the response has been received, the process 460 proceeds to block 464, wherein the data packet associated with the response is received. In some embodiments, this can include receiving all or one or several components of the data packet such as, for example, the response component of the data packet. In some embodiments, the data packet can be received by the response processor from the presentation engine.

After the data packet has been received, the process 460 proceeds to block 466, wherein the response type is identified. In some embodiments, this identification can be performed based on data, such as metadata associated with the response. In other embodiments, this identification can be performed based on data packet information such as the response component.

In some embodiments, the response type can identify one or several attributes of the one or several requests and/or questions of the data packet such as, for example, the request and/or question type. In some embodiments, this can include identifying some or all of the one or several requests and/or questions as true/false, multiple choice, short answer, essay, or the like.

After the response type has been identified, the process 460 proceeds to block 468, wherein the data packet and the response are compared to determine whether the response comprises a desired response and/or an undesired response. In some embodiments, this can include comparing the received response and the data packet to determine if the received response matches all or portions of the response component of the data packet, to determine the degree to which the received response matches all or portions of the response component, to determine the degree to which the receive response embodies one or several qualities identified in the response component of the data packet, or the like. In some embodiments, this can include classifying the response according to one or several rules. In some embodiments, these rules can be used to classify the response as either desired or undesired. In some embodiments, these rules can be used to identify one or several errors and/or misconceptions evidenced in the response. In some embodiments, this can include, for example: use of natural language processing software and/or algorithms; use of one or several digital thesauruses; use of lemmatization software, dictionaries, and/or algorithms; or the like.

After the data packet and the response have been compared, the process 460 proceeds to block 470 wherein response desirability is determined. In some embodiments this can include, based on the result of the comparison of the data packet and the response, whether the response is a desired response or is an undesired response. In some embodiments, this can further include quantifying the degree to which the response is a desired response. This determination can include, for example, determining if the response is a correct response, an incorrect response, a partially correct response, or the like. In some embodiments, the determination of response desirability can include the generation of a value characterizing the response desirability and the storing of this value in one of the databases 104 such as, for example, the user profile database 301. After the response desirability has been determined, the process 460 proceeds to block 472, wherein an assessment value is generated. In some embodiments, the assessment value can be an aggregate value characterizing response desirability for one or more a plurality of responses. This assessment value can be stored in one of the databases 104 such as the user profile database 301.

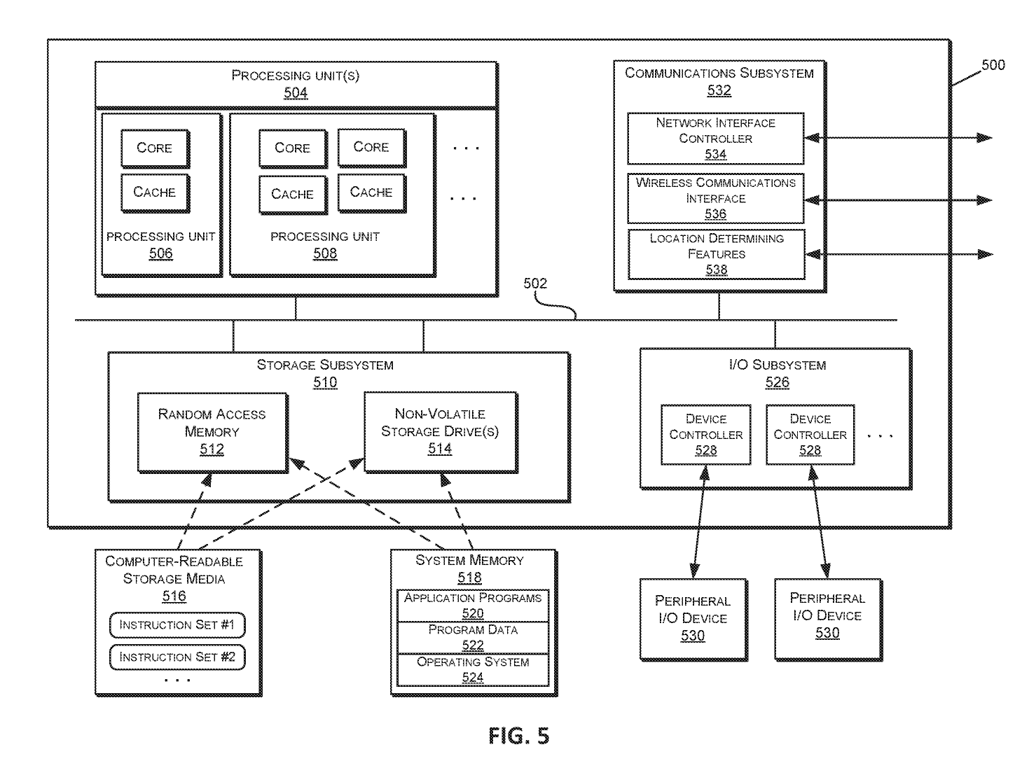

With reference now to FIG. 5, a block diagram of an illustrative computer system is shown. The system 500 may correspond to any of the computing devices or servers of the content distribution network 100 described above, or any other computing devices described herein, and specifically can include, for example, one or several of the user devices 106, the supervisor device 110, and/or any of the servers 102, 104, 108, 112, 114, 116. In this example, computer system 500 includes processing units 504 that communicate with a number of peripheral subsystems via a bus subsystem 502. These peripheral subsystems include, for example, a storage subsystem 510, an I/O subsystem 526, and a communications subsystem 532.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. Such architectures may include, for example, an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 504, which may be implemented as one or more integrated circuits (e.g., a conventional microprocessor or microcontroller), controls the operation of computer system 500. One or more processors, including single core and/or multicore processors, may be included in processing unit 504. As shown in the figure, processing unit 504 may be implemented as one or more independent processing units 506 and/or 508 with single or multicore processors and processor caches included in each processing unit. In other embodiments, processing unit 504 may also be implemented as a quad-core processing unit or larger multicore designs (e.g., hexa-core processors, octo-core processors, ten-core processors, or greater.

Processing unit 504 may execute a variety of software processes embodied in program code, and may maintain multiple concurrently executing programs or processes. At any given time, some or all of the program code to be executed can be resident in processor(s) 504 and/or in storage subsystem 510. In some embodiments, computer system 500 may include one or more specialized processors, such as digital signal processors (DSPs), outboard processors, graphics processors, application-specific processors, and/or the like.

I/O subsystem 526 may include device controllers 528 for one or more user interface input devices and/or user interface output devices 530. User interface input and output devices 530 may be integral with the computer system 500 (e.g., integrated audio/video systems, and/or touchscreen displays), or may be separate peripheral devices which are attachable/detachable from the computer system 500. The I/O subsystem 526 may provide one or several outputs to a user by converting one or several electrical signals to user perceptible and/or interpretable form, and may receive one or several inputs from the user by generating one or several electrical signals based on one or several user-caused interactions with the I/O subsystem such as the depressing of a key or button, the moving of a mouse, the interaction with a touchscreen or trackpad, the interaction of a sound wave with a microphone, or the like.

Input devices 530 may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. Input devices 530 may also include three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additional input devices 530 may include, for example, motion sensing and/or gesture recognition devices that enable users to control and interact with an input device through a natural user interface using gestures and spoken commands, eye gesture recognition devices that detect eye activity from users and transform the eye gestures as input into an input device, voice recognition sensing devices that enable users to interact with voice recognition systems through voice commands, medical imaging input devices, MIDI keyboards, digital musical instruments, and the like.

Output devices 530 may include one or more display subsystems, indicator lights, or non-visual displays such as audio output devices, etc. Display subsystems may include, for example, cathode ray tube (CRT) displays, flat-panel devices, such as those using a liquid crystal display (LCD) or plasma display, light-emitting diode (LED) displays, projection devices, touch screens, and the like. In general, use of the term “output device” is intended to include all possible types of devices and mechanisms for outputting information from computer system 500 to a user or other computer. For example, output devices 530 may include, without limitation, a variety of display devices that visually convey text, graphics and audio/video information such as monitors, printers, speakers, headphones, automotive navigation systems, plotters, voice output devices, and modems.

Computer system 500 may comprise one or more storage subsystems 510, comprising hardware and software components used for storing data and program instructions, such as system memory 518 and computer-readable storage media 516. The system memory 518 and/or computer-readable storage media 516 may store program instructions that are loadable and executable on processing units 504, as well as data generated during the execution of these programs.

Depending on the configuration and type of computer system 500, system memory 318 may be stored in volatile memory (such as random access memory (RAM) 512) and/or in non-volatile storage drives 514 (such as read-only memory (ROM), flash memory, etc.) The RAM 512 may contain data and/or program modules that are immediately accessible to and/or presently being operated and executed by processing units 504. In some implementations, system memory 518 may include multiple different types of memory, such as static random access memory (SRAM) or dynamic random access memory (DRAM). In some implementations, a basic input/output system (BIOS), containing the basic routines that help to transfer information between elements within computer system 500, such as during start-up, may typically be stored in the non-volatile storage drives 514. By way of example, and not limitation, system memory 518 may include application programs 520, such as client applications, Web browsers, mid-tier applications, server applications, etc., program data 522, and an operating system 524.

Storage subsystem 510 also may provide one or more tangible computer-readable storage media 516 for storing the basic programming and data constructs that provide the functionality of some embodiments. Software (programs, code modules, instructions) that when executed by a processor provide the functionality described herein may be stored in storage subsystem 510. These software modules or instructions may be executed by processing units 504. Storage subsystem 510 may also provide a repository for storing data used in accordance with the present invention.

Storage subsystem 300 may also include a computer-readable storage media reader that can further be connected to computer-readable storage media 516. Together and, optionally, in combination with system memory 518, computer-readable storage media 516 may comprehensively represent remote, local, fixed, and/or removable storage devices plus storage media for temporarily and/or more permanently containing, storing, transmitting, and retrieving computer-readable information.

Computer-readable storage media 516 containing program code, or portions of program code, may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 500.

By way of example, computer-readable storage media 516 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 516 may include, but is not limited to, Zip® drives, flash memory cards, universal serial bus (USB) flash drives, secure digital (SD) cards, DVD disks, digital video tape, and the like. Computer-readable storage media 516 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Communications subsystem 532 may provide a communication interface from computer system 500 and external computing devices via one or more communication networks, including local area networks (LANs), wide area networks (WANs) (e.g., the Internet), and various wireless telecommunications networks. As illustrated in FIG. 5, the communications subsystem 532 may include, for example, one or more network interface controllers (NICs) 534, such as Ethernet cards, Asynchronous Transfer Mode NICs, Token Ring NICs, and the like, as well as one or more wireless communications interfaces 536, such as wireless network interface controllers (WNICs), wireless network adapters, and the like. As illustrated in FIG. 5, the communications subsystem 532 may include, for example, one or more location determining features 538 such as one or several navigation system features and/or receivers, and the like. Additionally and/or alternatively, the communications subsystem 532 may include one or more modems (telephone, satellite, cable, ISDN), synchronous or asynchronous digital subscriber line (DSL) units, FireWire® interfaces, USB® interfaces, and the like. Communications subsystem 536 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

The various physical components of the communications subsystem 532 may be detachable components coupled to the computer system 500 via a computer network, a FireWire® bus, or the like, and/or may be physically integrated onto a motherboard of the computer system 500. Communications subsystem 532 also may be implemented in whole or in part by software.

In some embodiments, communications subsystem 532 may also receive input communication in the form of structured and/or unstructured data feeds, event streams, event updates, and the like, on behalf of one or more users who may use or access computer system 500. For example, communications subsystem 532 may be configured to receive data feeds in real-time from users of social networks and/or other communication services, web feeds such as Rich Site Summary (RSS) feeds, and/or real-time updates from one or more third party information sources (e.g., data aggregators 311). Additionally, communications subsystem 532 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 532 may output such structured and/or unstructured data feeds, event streams, event updates, and the like to one or more data stores 104 that may be in communication with one or more streaming data source computers coupled to computer system 500.

Due to the ever-changing nature of computers and networks, the description of computer system 500 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

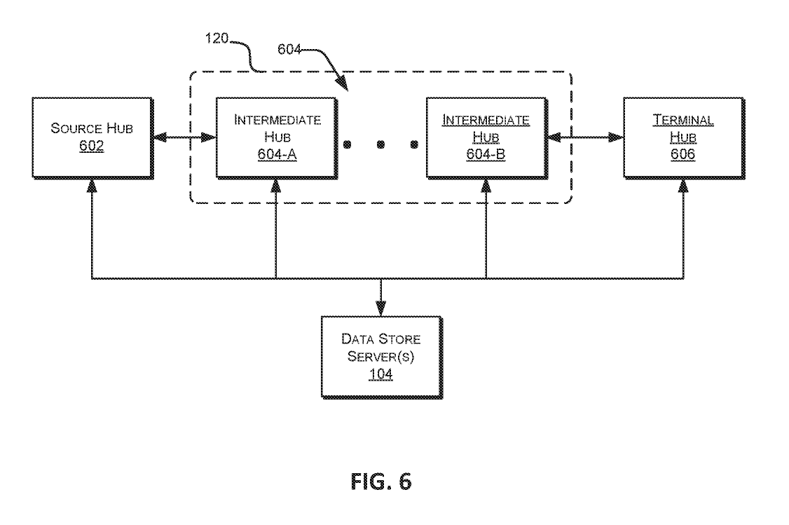

With reference now to FIG. 6, a block diagram illustrating one embodiment of the communication network is shown. Specifically, FIG. 6 depicts one hardware configuration in which messages are exchanged between a source hub 602 via the communication network 120 that can include one or several intermediate hubs 604. In some embodiments, the source hub 602 can be any one or several components of the content distribution network generating and initiating the sending of a message, and the terminal hub 606 can be any one or several components of the content distribution network 100 receiving and not re-sending the message. In some embodiments, for example, the source hub 602 can be one or several of the user device 106, the supervisor device 110, and/or the server 102, and the terminal hub 606 can likewise be one or several of the user device 106, the supervisor device 110, and/or the server 102. In some embodiments, the intermediate hubs 604 can include any computing device that receives the message and resends the message to a next node.

As seen in FIG. 6, in some embodiments, each of the hubs 602, 604, 606 can be communicatingly connected with the data store 104. In such an embodiments, some or all of the hubs 602, 604, 606 can send information to the data store 104 identifying a received message and/or any sent or resent message. This information can, in some embodiments, be used to determine the completeness of any sent and/or received messages and/or to verify the accuracy and completeness of any message received by the terminal hub 606.

In some embodiments, the communication network 120 can be formed by the intermediate hubs 604. In some embodiments, the communication network 120 can comprise a single intermediate hub 604, and in some embodiments, the communication network 120 can comprise a plurality of intermediate hubs. In one embodiment, for example, and as depicted in FIG. 6, the communication network 120 includes a first intermediate hub 604-A and a second intermediate hub 604-B.

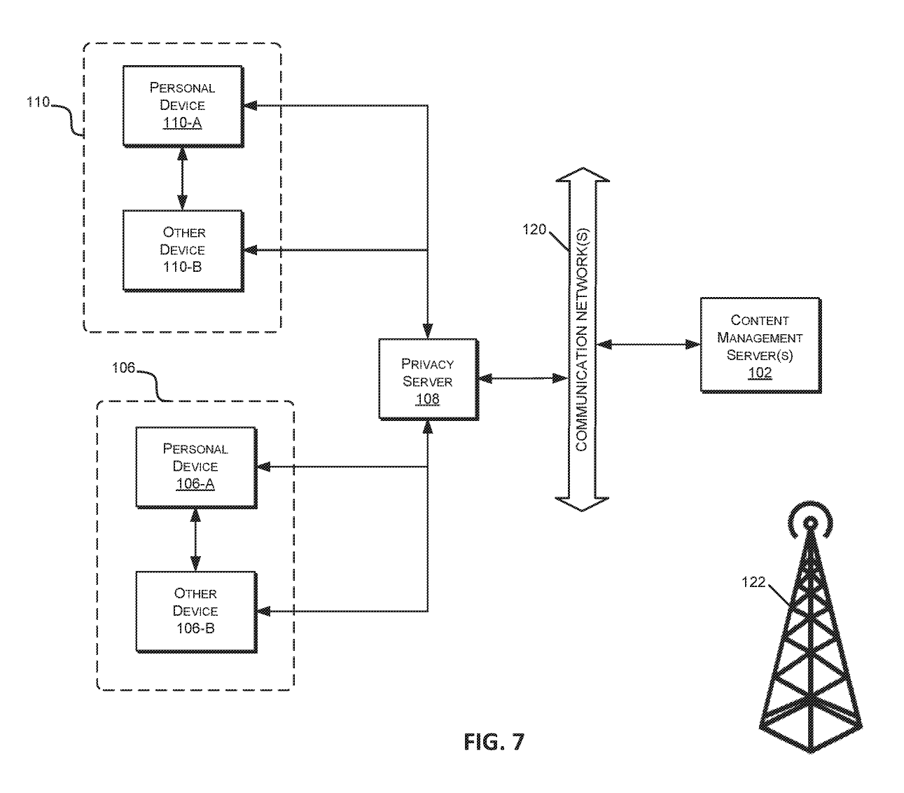

With reference now to FIG. 7, a block diagram illustrating one embodiment of user device 106 and supervisor device 110 communication is shown. In some embodiments, for example, a user may have multiple devices that can connect with the content distribution network 100 to send or receive information. In some embodiments, for example, a user may have a personal device such as a mobile device, a Smartphone, a tablet, a Smartwatch, a laptop, a PC, or the like. In some embodiments, the other device can be any computing device in addition to the personal device. This other device can include, for example, a laptop, a PC, a Smartphone, a tablet, a Smartwatch, or the like. In some embodiments, the other device differs from the personal device in that the personal device is registered as such within the content distribution network 100 and the other device is not registered as a personal device within the content distribution network 100.

Specifically with respect to FIG. 7, the user device 106 can include a personal user device 106-A and one or several other user devices 106-B. In some embodiments, one or both of the personal user device 106-A and the one or several other user devices 106-B can be communicatingly connected to the content management server 102 and/or to the navigation system 122. Similarly, the supervisor device 110 can include a personal supervisor device 110-A and one or several other supervisor devices 110-B. In some embodiments, one or both of the personal supervisor device 110-A and the one or several other supervisor devices 110-B can be communicatingly connected to the content management server 102 and/or to the navigation system 122.

In some embodiments, the content distribution network can send one or more alerts to one or more user devices 106 and/or one or more supervisor devices 110 via, for example, the communication network 120. In some embodiments, the receipt of the alert can result in the launching of an application within the receiving device, and in some embodiments, the alert can include a link that, when selected, launches the application or navigates a web-browser of the device of the selector of the link to page or portal associated with the alert.

In some embodiments, for example, the providing of this alert can include the identification of one or several user devices 106 and/or student-user accounts associated with the student-user and/or one or several supervisor devices 110 and/or supervisor-user accounts associated with the supervisor-user. After these one or several devices 106, 110 and/or accounts have been identified, the providing of this alert can include determining an active device of the devices 106, 110 based on determining which of the devices 106, 110 and/or accounts are actively being used, and then providing the alert to that active device.

Specifically, if the user is actively using one of the devices 106, 110 such as the other user device 106-B and the other supervisor device 110-B, and/or accounts, the alert can be provided to the user via that other device 106-B, 110-B and/or account that is actively being used. If the user is not actively using another device 106-B, 110-B and/or account, a personal device 106-A, 110-A device, such as a smart phone or tablet, can be identified and the alert can be provided to this personal device 106-A, 110-A. In some embodiments, the alert can include code to direct the default device to provide an indicator of the received alert such as, for example, an aural, tactile, or visual indicator of receipt of the alert.

In some embodiments, the recipient device 106, 110 of the alert can provide an indication of receipt of the alert. In some embodiments, the presentation of the alert can include the control of the I/O subsystem 526 to, for example, provide an aural, tactile, and/or visual indicator of the alert and/or of the receipt of the alert. In some embodiments, this can include controlling a screen of the supervisor device 110 to display the alert, data contained in alert and/or an indicator of the alert.

Diagnostic assessment (or validation, evaluation, test, exam, or the like) uses the diagnostic classification models (DCMs) to determine mastery or non-mastery (or, for example, indifference) of a set of attributes and to provide strengths and weaknesses. Diagnostic assessment can include fixed form or adaptive assessments. Adaptive assessments may be variable-length, where a status (e.g. mastery) for an attribute or a profile classification is sufficiently certain, the assessment may be terminated early (i.e. before all queries have been answered). This process may save time, money, computer or network bandwidth, among other resources.

Two critical components in adaptive diagnostic assessment are (1) item selection algorithms; and (2) termination rules. During adaptive testing, content items (e.g. items, queries, or questions) may be sequentially selected, one content item at a time, based on the performance of a user (e.g. a respondent to the queries) on the previous items. Each time a new content item is received from the respondent (e.g. because the user has completed the new item), the posterior distribution of the attribute profile for the user is updated to incorporate new information provided by the new content item(s). A set of termination criteria may then be checked to determine if the test may be terminated. If conditions for termination are satisfied, and the minimum test length (to confirm that the test is not terminated too early and enough items are received from the user) or maximum test length (to confirm that the assessment does not last too long) are fulfilled, then the assessment may be terminated. However, if conditions for termination are not yet satisfied, the test continues until it finally meets the criteria.

For classification of a user when participating in an assessment, such as to determine whether a user has mastery or non-mastery for a certain attribute, different statistics or metrics may be used. For example, a posterior probability for attribute profile may be used. A posterior probability for attribute profile may be described as, for example, the probability of assigning one or more observations (e.g. mastery, non-mastery, etc.) to a group given the data, or content items, already received and processed. More specifically, a posterior probability for attribute profile may be described as a vector of probability value for each possible combination of attribute states. For example, for three-attribute tests, the possible profile patterns may include [000, 001, 010, 100, 110, 101, 011, 111] and the posterior probability for those eight profile patterns can be estimated (e.g. the posterior probability for those example profile patterns may be [0.01, 0.01, 0.15, 0.01, 0.01, 0.01, 0.50, 0.30], where 011 is the estimated profile because it has the highest posterior probability) based on items already answered and a prior distribution of evaluation takers' ability. As noted with respect to 011 in the above example, the posterior probability may refer to the maximum value in the vector of the posterior probability. In another example, a posterior marginal probability for attributes may be used.

A system or method for adaptive diagnostic assessment may include a variety of different components or steps. In an assessment, one or more queries may be transmitted to or otherwise viewed by a user (e.g. an assesse, a test taker, a student, etc.). The user may then transmit or otherwise select a response to the query. When a response is received from the user, an evaluation may be made based on the user's response. For example, the assessment may have one or more attributes, and the query and/or response content resources may provide data regarding one or more of those attributes with respect to the user. The query and/or response may be stored in a content library database, such as content library database 303 in FIG. 3, or in another storage unit. The content library database may identify one or more aspects or content attributes of the associated content resources, for example, subject matter, access level, or skill level of the content resources, license attributes of the content resources (e.g., any limitations and/or restrictions on the licensable use and/or distribution of the content resource), price attributes of the content resources (e.g., a price and/or price structure for determining a payment amount for use or distribution of the content resource), rating attributes for the content resources (e.g., data indicating the evaluation or effectiveness of the content resource), and the like. After the evaluation content has been provided, an evaluation score, also referred to herein as a validation score, may be determined. In some embodiments, this can include receiving one or several user inputs in response to the content of the validation, and determining the accuracy and/or quality of those one or several user inputs. In some embodiments, the validation score can be generated according to, for example, diagnostic classification models (DCMs), and the score can be strengths and weaknesses on attributes.

As noted, the evaluation may last for a certain length. The length may be determined based on a variety of factors, including how many queries have been transmitted to or otherwise viewed by the user, how many queries the user has answered, how many queries the user has answered correctly, how many queries the user has answered incorrectly, how much time has passed since the user began the evaluation, among other factors. However, other conditions for termination may also be applied to the evaluation.

Conditions or criteria for termination may include a variety of different parameters, rules or thresholds, such as a termination or cut threshold. In some embodiments, for example, the termination rule can be one or several values associated with the participant's validation and that can be used to determine when to terminate a validation apart from determining that the participant has passed the validation. In other embodiments, the termination parameter can include, for example, the number of content items provided to the participant, the number of content items responded to by the participant, the amount of time used by the participant in the validation, or the like.

For example, a termination rule may state that an assessment will be terminated if a determined posterior probability exceeds a certain predetermined threshold posterior probability. In another example, a termination rule may state that an assessment will be terminated if a determined marginal posterior probability exceeds a certain predetermined threshold posterior probability.

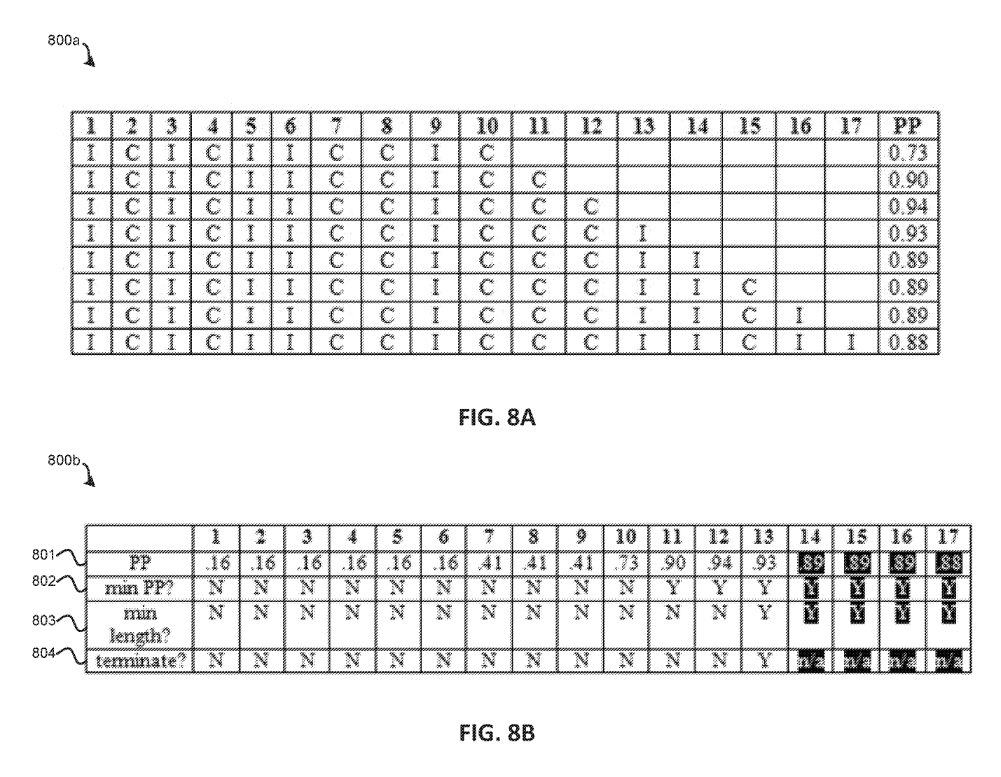

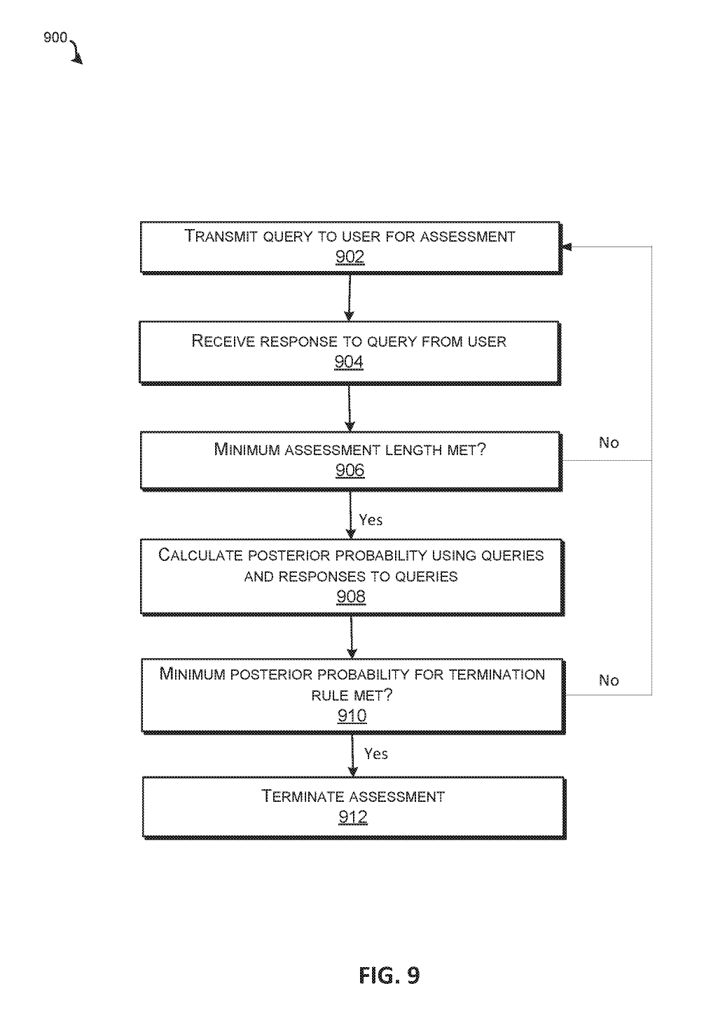

FIGS. 8A and 8B are tables that include content items associated with a user, according to embodiments of the present technology. FIG. 8A shows table 800a, which includes raw data (i.e. content items) associated with example queries 1-17, and the user's responses to the queries for each answer, according to embodiments of the present technology. Each line of table 800a is updated with a new content item, or in other words a new response to a query by the user. The right-most column of table 800a includes, for example, the posterior probability determined after each content item is received. For example, the posterior probability associated with an attribute after the user has responded to the first ten queries of the evaluation is 0.73. In other words, the probability that, based on the content data received from the user, the user falls within a certain group of mastery or non-mastery, is 0.73 or 73%. In another example, the posterior probability associated with an attribute after the user has responded to the first eleven queries of the evaluation is 0.90. The posterior probability associated with an attribute after the user has responded to the first twelve through seventeen queries of the evaluation are 0.94, 0.93, 0.89, 0.89, 0.89 and 0.88, respectively.

As noted, in some embodiments, the termination threshold (or “cut” threshold) can include information used to determine when a evaluate, also referred to herein as a testee, a participant, a test taker, a student, a trainee, a learner, or the like, has demonstrated sufficient mastery and/or knowledge to pass the validation. In some embodiments, the cut threshold can identify, for example, a score, a minimum percent correct, a maximum percent incorrect, a maximum number of improperly responded to content items, or the like. In some embodiments, the cut threshold can further include one or several statistical measures to quantify acceptable and/or unacceptable levels of uncertainty in a score. In some embodiments, this can include, for example, one or several confidence scores, one or several confidence intervals such as a minimum confidence interval and/or a maximum confidence interval, or the like. The cut threshold can be received from a user or other source via, for example, a user or other device, and can be stored in a database.

FIG. 8B shows table 800b, which includes posterior probability data associated with example queries 1-17 and data associated with additional termination conditions, according to embodiments of the present technology. Row 801 includes posterior probability data associated with each of example queries 1-17. As noted, one method of determining whether an evaluation should be terminated is based on whether the posterior probability for profile has exceeded a certain predetermined threshold posterior probability. For example, in a situation where the minimum posterior probability to be achieved for this condition to be met (and, therefore, the evaluation to be terminated) is 0.80, the data associated with the user in table 800b would reach that threshold after query 11 has been answered (when the posterior probability rose from 0.73 to 0.90), as shown in row 802. However, another condition that may be required for the evaluation to terminate is a minimum length condition, which may require that a certain number of queries of the evaluation be transmitted or otherwise viewed or answered by the user for the evaluation to terminate. In a situation where the minimum length condition is 13 queries, this condition would be met after the thirteenth query, as shown in column 13 of row 803. Assuming both conditions (minimum posterior probability and minimum length) need to be satisfied before the evaluation may be terminated, the evaluation may be terminated after the thirteenth query, as shown in row 804. In table 800b, data associated with columns 14-17 are also shown (in white text with black backgrounds) for completeness, but are not relevant in this example because the evaluation may terminate after the thirteenth query (i.e. the data in columns 14-17 may never happen in that example). However, in other situations with different conditions for termination, data in columns 14-17 may be received and may be added to the content items stored and associated with the user.

Another type of termination rule (e.g. without using the probability) may include testing information. For example, the posterior probability weighted KL (PWKL) information may be used as a statistic for adaptive item selection, which selects items with larger PWKL values. This rule may include conditional standard error of measurement (CSEM) in item response theory (IRT), where the CSEM is, for example, the reciprocal of the squared root of test information, to define CSEM_PWKL=1/sqrt(sum(PWKL). As the assessment moves forward, the information (i.e. PWKL) gets larger and the measure error (i.e. CSEM_PWKL) gets smaller. When the CSEM_PWKL is smaller than a predefined value, the assessment may stop.

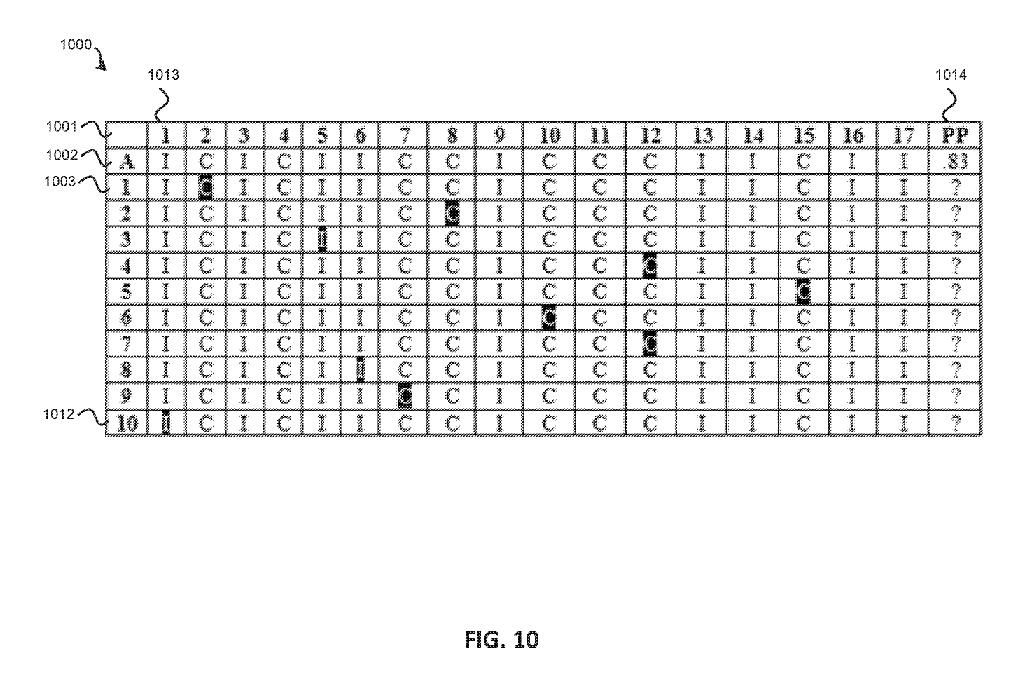

FIG. 9 is a flow chart 900 of an example process used to process content items and terminate an assessment based on an adaptive diagnostic assessment approach, according to embodiments of the present technology. Flow chart 900 include steps of a process that may be performed by a variety of different devices, such as content management server 102 described with respect to FIG. 1, server 202 described with respect to FIG. 2, or other devices or systems described herein.

Process 900 begins with step 902, wherein a query may be transmitted to a user during an assessment. This query may be one of a set of one or more queries transmitted to or otherwise viewed by the user during a diagnostic assessment. The process 900 then proceeds to step 904, which includes receiving a response to the query from the user. This response, along with the query and any other query/response combinations that are part of the assessment, contribute to data packets of content items to be stored and analyzed as part of the assessment process.

Step 904 includes determining whether a minimum assessment length has been met. As noted, the assessment may include a minimum assessment length. For example, this minimum length may include factors such as how many queries have been transmitted to or otherwise viewed by the user, how many queries the user has answered, how many queries the user has answered correctly, how many queries the user has answered incorrectly, how much time has passed since the user began the evaluation, among other factors. If the minimum assessment length has not been met, then the process may return to step 902 for another query to be transmitted to the user to proceed with the rest of the assessment. If the minimum assessment length has been met, then the process may proceed to step 908, wherein a posterior probability for profile may be calculated using the queries and responses to queries from the assessment thus far. In another example, step 908 may be performed before step 906 such that posterior probabilities are determined after each response is received from a user so that even if the minimum assessment length is not met and the process reverts back to step 902, the posterior probability is determined after each query and response is collected.

After step 908, the process proceeds to step 910, where it is determined whether the calculated posterior probability exceeds a minimum posterior probability threshold. If the calculated posterior probability does not exceed the minimum posterior probability threshold, then the process again reverts back to step 902 for another query to be transmitted to the user to proceed with the rest of the assessment. If, on the other hand, the calculated posterior probability does exceed the minimum posterior probability threshold, then the process proceeds to step 912, wherein the assessment terminates. In some embodiments, this comparison can determine whether the termination parameter exceeds, meets, or does not exceed the termination threshold. In some embodiments, the threshold number has been reached when the number being compared with the threshold is greater than the threshold number. In other embodiments, the threshold number has been reached when the number being compared with the threshold is greater than or equal to the threshold number.

In an embodiment, a threshold number may be predetermined and received from, for example, a user. In another embodiment, a threshold number may be determined. In some embodiments, the threshold number can identify a minimum number of content items associated with the topic to meet the requirements of the cut threshold. In some embodiments, this minimum number can be calculated based on the one or several statistical measures of confidence associated with the threshold such as, for example, the confidence interval. In some embodiments, the threshold number can be a multiple of the minimum number of content items to meet the cut threshold to provide for the possibility of inconsistent responses to the content items such as, for example, both correct and incorrect responses to content items associated with the topic.

As noted, when using the posterior probability as a termination rule, the assessment may terminate when the posterior probability calculated based on collected content items exceeds a predetermined threshold value (e.g. 0.8). However, a posterior probability may experience a large increase or drop based on a small amount of new content items. For example, referring back to the example data shown in table 800b of FIG. 8B, from the sixth query to the seventh query and their corresponding responses received, the posterior probability increased from 0.16 to 0.41, from the ninth query to the tenth query and their corresponding responses received, the posterior probability increased from 0.41 to 0.73, and from the tenth query to the eleventh query and their corresponding responses received, the posterior probability increased from 0.73 to 0.90. Therefore, one new content item may have a large impact on the posterior probability for an attribute during an assessment. Due to this large impact, although a posterior probability may increase and exceed a predetermined posterior probability threshold, this increase may not actually indicate that the results of the assessment reflect an accurate diagnostic assessment of the user. In other words, although the assessment may be terminated due to the posterior probability exceeding the threshold, the user may benefit from additional assessment to yield a more accurate result.

Multiple solutions may be possible to solve this problem. In a first solution, a termination rule may require that an assessment is not eligible to be terminated until the minimum posterior probability has exceeded the posterior probability threshold, and remains above the threshold for a predetermined amount of time. For example, a termination rule may require that the minimum posterior probability has exceeded the posterior probability threshold, and remains above the threshold for a certain predetermined number of queries and query responses. In another example, a termination rule may require that the minimum posterior probability has exceeded the posterior probability threshold, and remains above the threshold for a certain predetermined amount of time. In another example, a termination rule may require that the minimum posterior probability has exceeded the posterior probability threshold, and the minimum posterior probability does not decrease for a certain number of queries and query responses. Referring back to the flow chart in FIG. 9, such a solution may require adding a step in between steps 910 and 912 that includes determining that the minimum posterior probability for termination rule has been met for a certain predetermined amount of time before proceeding to step 912 where the assessment is terminated. In one example, if the minimum posterior probability for termination rule has not been met for the certain predetermined amount of time, then the process may proceed back to step 902 instead of proceeding to step 912.

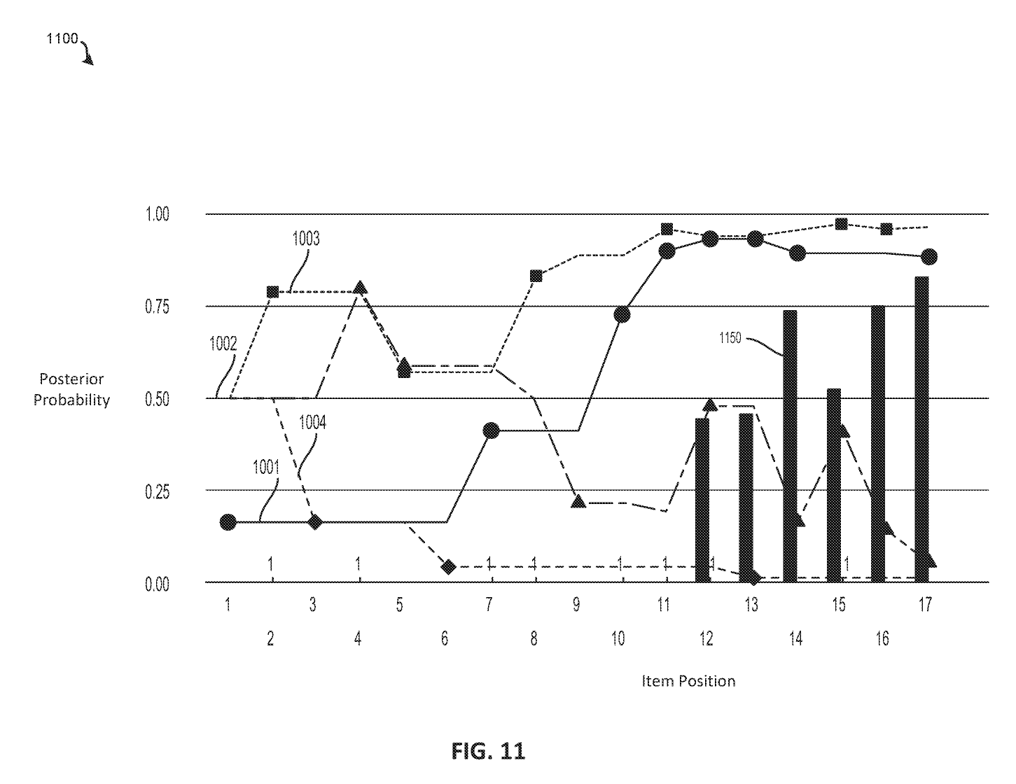

In an alternative embodiment, a termination rule with bootstrap sampling may be used. More specifically, an estimated error may be calculated by sampling data associated with content items to determine the stability of estimates of the posterior probability for attributes throughout a diagnostic assessment. FIG. 10 shows table 1000, which includes ten iterations of sampling as applied to data associated with example queries 1-17 and corresponding responses, according to embodiments of the present technology. Row 1001 of table 1000 shows the number of the query and corresponding response to the query that the data below the number is associated with. For example, the number “1” in column 1013 indicates that the data below the “1” shows the response from the user to query number one. Row 1002 includes seventeen content items (N content items, where N=17), namely each of the responses given to queries 1-17 by the user. Rows 1003 through 1012, however, each show different iterations of the sampling process applied to the content items. For example, each of rows 1003 through 1012 began with the same data, namely the responses given to queries 1-17 by the user. However, each different iteration, as shown in each row of table 1000, include sixteen content items, each of which include a random sampling of the 17 responses given by the user, to yield sample sets of content items in each row (e.g. in this case, each row has 16 randomly selected of the 17 total responses). For example, the content item (or, in other embodiments, content items) that was not selected in each iteration as one of the 16 items selected from the 17 responses is shown in white text and black background in FIG. 10. Column 1014 indicates the posterior probability associated with each sampling, or with each row of content items as compiled from the user. In other words, the posterior probability is determined for each iteration after a sampling has been completed. As shown in column 1014, the posterior probability for the whole set of seventeen content items in row 1002 is 0.83. This process yields one posterior probability calculation for each sampling iteration. After posterior probability determinations are made for each sampling iteration, a Standard Error of posterior probability Estimates (SEE) (or a standard deviation of the sampling distribution) may be calculated to determine the stability of estimates of the posterior probability for attributes throughout a diagnostic assessment. Other types of error calculations may also be used.

While table 1000 in FIG. 10 shows only ten samples (as shown by data in rows 1003-1012), the sampling process may be completed over any number of samples (e.g. 100, 1000, or any other number). However, the more iterations that are completed during the sampling process, the longer it may take to complete the process.

The SEE calculated using sampling of the content items may then be used to confirm that the assessment should actually be terminated, and to confirm that the assessment would not be, just based on the initial posterior probability calculation, terminated too early. A second threshold may be generated to make such a confirmation. For example, a predetermined SEE threshold may be stored or generated to compare against the calculated SEE (e.g. 0.2, 0.25, 0.3 or any other number between 0 and 1). If the calculated SEE is lower than the SEE threshold, then the calculated SEE may be determined to be low enough to confirm that the posterior probability (calculated using the content items, shown in row 1002 of table 1000) is sufficiently accurate. If the posterior probability is deemed to be sufficiently accurate, the posterior probability may be used to determine if the assessment should be terminated. If, on the other hand, the calculated SEE is higher than the SEE threshold, then the calculated SEE may be determined to be too high to confirm that the posterior probability is sufficiently accurate. If the posterior probability is deemed to not be sufficiently accurate, then the posterior probability may not be used to determine if the assessment should be terminated, and/or the assessment may be continued with one or more additional queries. In other words, the SEE calculation and SEE threshold may be used as a second or back-up check point or confirmation for termination.

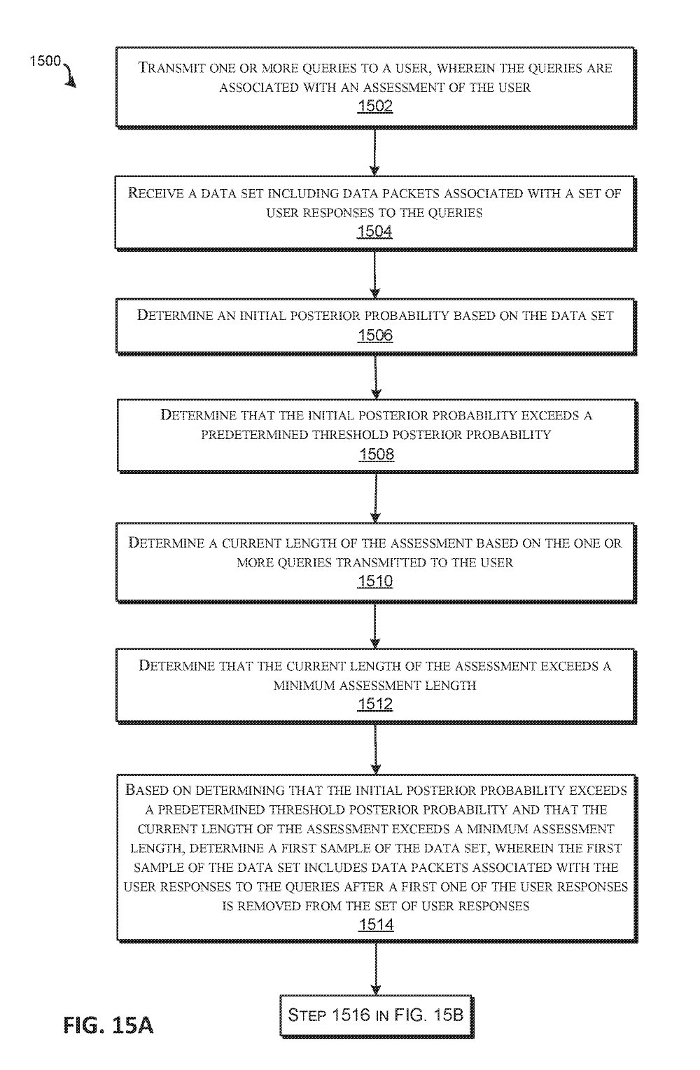

The process to terminate an assessment, or to determine whether an assessment should be terminated, may include two or more different determined statistics compared to different thresholds. In a first step, after the posterior probability for a set of content items is determined, sampling may be used to determine if the determined posterior probability is within a certain threshold error (e.g. SEE) to be used to determine whether the assessment should be terminated. If the SEE is lower than a predetermined threshold, then the posterior probability may be used to determine termination. In a second step, the posterior probability calculated using the set of content items may be compared to a posterior probability threshold. If the posterior probability is greater than the posterior probability threshold, then the assessment may be terminated. If the posterior probability is lower than the posterior probability threshold, then the assessment may be not terminated, and may continue. However, the first and second steps described in this example process may be switched such that the “second” step may occur first. An example of such a process is shown in FIG. 14.

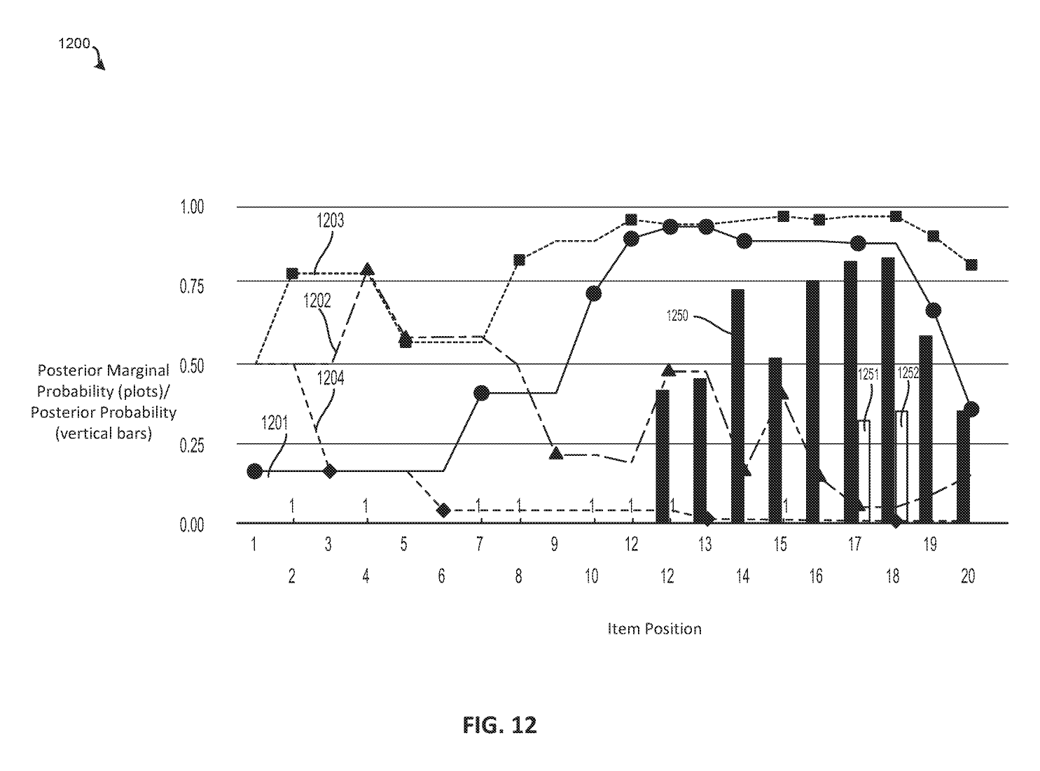

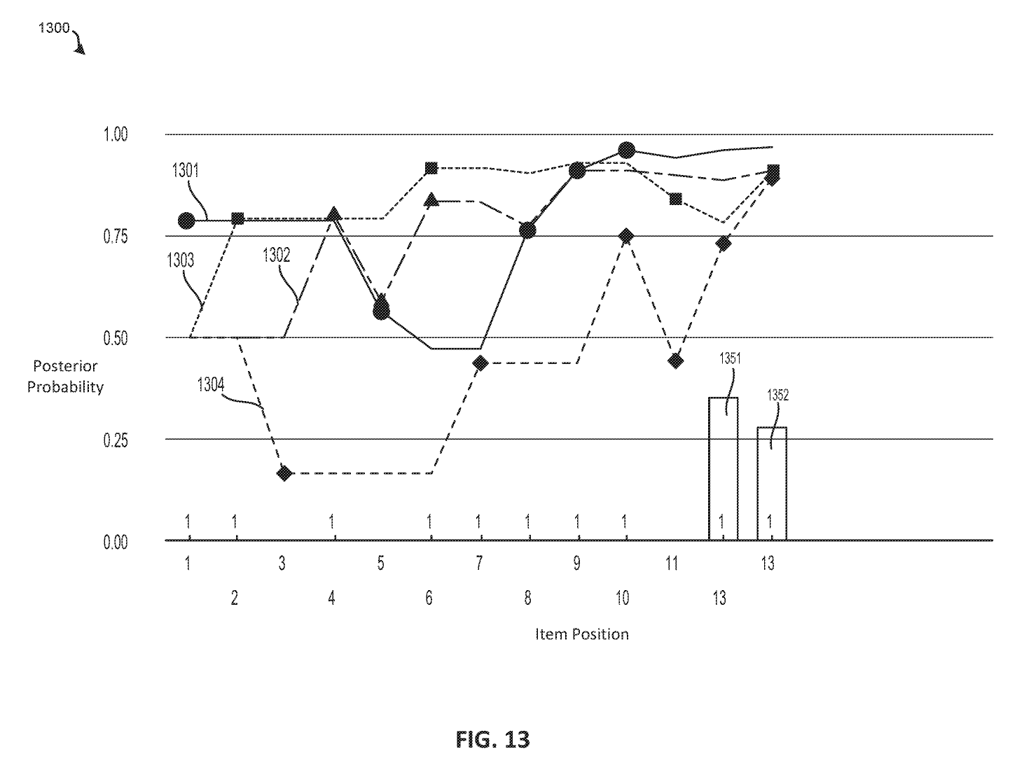

FIGS. 11-12 show graphs with plots of content items associated with an assessment for different attributes associated with a user of the assessment, according to embodiments of the present technology. FIG. 11 shows a graph 1100 with four plots, plot 1101 (circle), plot 1102 (triangle), plot 1103 (square) and plot 1104 (diamond), each representing user posterior marginal probability for attributes, according to embodiments of the present technology. The user posterior marginal probability for attributes value may indicate that the user is more likely to be in the “mastery” status (close to 1; for example, over 0.8) or in the “non-mastery” status (close to 0; for example, under 0.2). Plots 1101-1104 represent data corresponding to content items associated with each of four different attributes associated with a user (e.g. the user that received queries of the assessment and responded to the queries with answers). The y-axis of graph 1100 represents posterior marginal probability for the four plots 1101-1104, and represents posterior probability for profile for the vertical bars 1150. The x-axis of graph 1100 is the item position (e.g. query) number of the assessment. Therefore, the data plots of graph 1100 associated with each item position represent the posterior marginal probability for that data's corresponding attribute based on the queries and responses received to that point (item position). Furthermore, located just above its x-axis, graph 1100 includes a number “1” for any query where “1 point” (e.g. correct answer) was received from the user. Graph 1100 does not include any calculations of SEE, and does not use bootstrap sampling or any other type of sampling to make a determination about termination of the assessment.

Assume that the termination rule for the content items represented by graph 1100 include a minimum assessment length of twelve, a maximum assessment length of 20, and a minimum posterior probability (threshold) of 0.8 for profile. The item positions 1-11 do not include vertical bars representing profile probability (profile probability and posterior probability for profile may be used interchangeably) for those item positions because the minimum test length is 12, and therefore termination rule is not applied. As shown by graph 1100, the assessment represented by graph 1100 and the content items shown in graph 1100 terminates after item position 17. The assessment terminates after item position 17 because the posterior marginal probability exceeds the minimum posterior probability (0.8) for the first time after item position 17 at a value of 0.83 (as shown in graph 1100, the posterior probability for items 12-16 is 0.45, 0.46, 0.74, 0.52 and 0.73, respectively). Since, at item position 17, the minimum assessment length of 12 has been exceeded and the minimum posterior probability of 0.80 has been exceeded, the assessment may be terminated. In other words, at item 17, the posterior marginal probability for the four attributes shown in graph 1100 are either above 0.8 or below 0.2, so the first step of the termination rule is satisfied.

Furthermore, as shown in FIG. 11, when profile probability is the only assessment mechanism used as part of the termination rule, the profile probability can rise and drop erratically, and progress of only one or two item positions may change the profile probability drastically. For example, from item position 13 to item position 14, the profile probability rises from 0.46 to 0.74. In another example, from item position 14 to item position 15, the profile probability drops from 0.74 to 0.52. In another example, from item position 15 to item position 16, the profile probability rises from 0.52 to 0.75. In another example, from item position 16 to item position 17 (after which the assessment is terminated), the profile probability rises from 0.0.75 to 0.83. The use of an additional threshold, such as bootstrap SEE (described more with respect to FIG. 12), can prevent termination of the assessment prematurely after a drastic increase in posterior probability.

As noted, the plots 1101-1104 in graph 1100 represent posterior marginal probability for attributes. In the example described above with respect to FIG. 11, posterior marginal probability for attributes is not used as part of the termination rule. However, in another embodiment, posterior marginal probability for attributes may be used as part of the termination rule. In such an embodiment, the termination rule may be set such that the rule is satisfied if the posterior marginal probability for attributes are all either above 0.8 (mastery) or below 0.2 (non-mastery). There are several other termination rules (e.g. CSEM_PWKL), other than posterior probability for profile and posterior marginal probability for attributes mentioned above, that can be used as the first (or only) step of the termination rule. The bootstrap threshold may be supplementary as the second step for the tests that are used to make all or only certain important decisions.

FIG. 12 shows a graph 1200 with four plots, plot 1201, 1202, 1203 and 1204, representing user profile attributes, according to embodiments of the present technology. Like graph 1100 in FIG. 11, plots 1201-1204 represent data corresponding to content items associated with each of four different attributes associated with a user (e.g. the user that received queries of the assessment and responded to the queries with answers). The y-axis of graph 1200 is posterior marginal probability and is profile probability for the dark vertical bars, and the x-axis of graph 1200 is the item position (e.g. item, or query) number of the assessment. Therefore, the data plots of graph 1200 associated with each item position represent the posterior probability for that data's corresponding attribute based on the queries and responses received to that point (item position). The data used to create plots 1201-1204 are the same posterior marginal probability data as in graph 1100, calculated for each attribute based on the content items collected from the assessment and the user. As such, graph 1200 shows that the same assessment results are represented in graph 1200 as in graph 1100 as shown by the “1 point” associated with each respective item position.

The dark vertical bars (e.g. vertical bar 1250) located above each of item positions 12-20 represent the profile probability for the content items. The vertical bars 1251 and 1252 represent the bootstrap SEE calculated for each of item positions 17 and 18, respectively. Further description on calculation of the bootstrap SEE is described herein with respect to FIG. 10.

Similar to graph 1100 in FIG. 11, assume that the termination rule for the content items represented by graph 1200 include a minimum assessment length of twelve, a maximum assessment length of 20, and a minimum posterior probability (threshold) of 0.8 for profile. The item positions 1-11 do not include vertical bars representing profile probability for those item positions because the minimum test length is 12, and therefore the termination rule is not applied. In addition, assume that the termination rule for the content items represented by graph 1200 also includes an SEE of 0.3. Unlike in graph 1100, the assessment represented by graph 1200 and the content items shown in graph 1200 does not terminate after item position 17, and instead completes the assessment to the maximum of 20 queries. The assessment does not terminate after item position 17 even though the posterior probability for profile exceeds the minimum posterior probability (0.8) for the first time after item position 17 at a value of 0.83 because the bootstrap SEE at position 17 (and at position 18, for example) are not below the maximum SEE threshold of 0.3. Since, at item position between 12 and 20, either the minimum posterior probability of 0.80 is not exceeded or the bootstrap SEE threshold of 0.3 is not exceeded, the assessment is not terminated before the final item position 20.

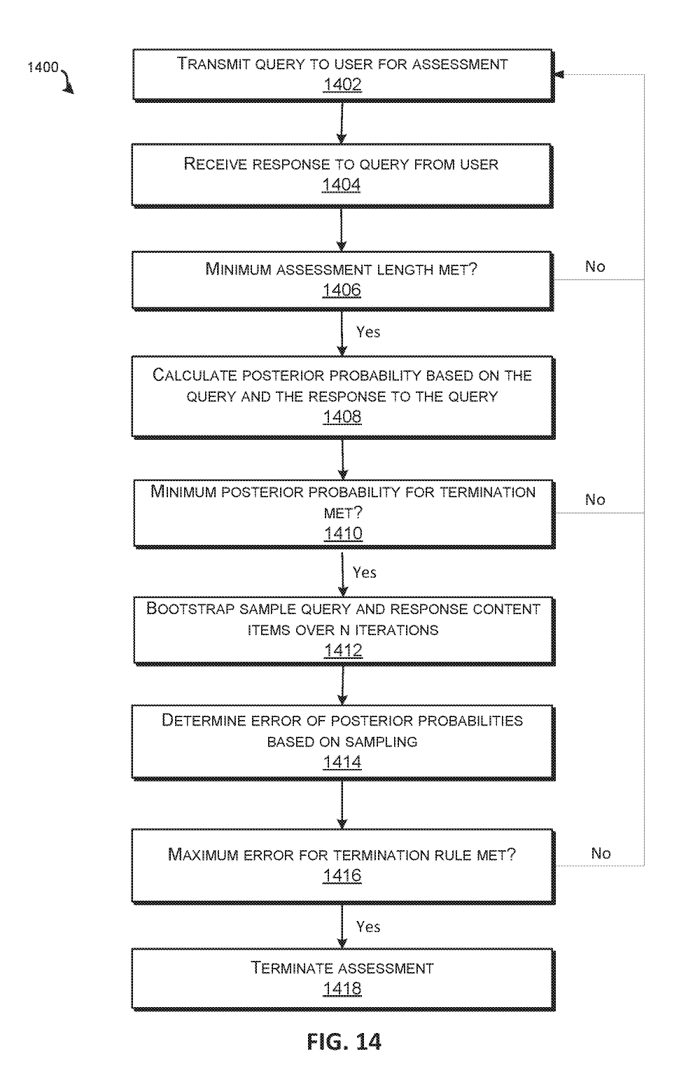

FIG. 13 shows a graph 1300 with four plots, plot 1301, 1302, 1303 and 1304, representing user profile attributes, according to embodiments of the present technology. Like graphs 1100 and 1200, plots 1301-1304 represent data corresponding to content items associated with each of four different attributes associated with a user (e.g. the user that received queries of the assessment and responded to the queries with answers). The y-axis of graph 1300 is posterior attribute probability, and the x-axis of graph 1300 is the item position (e.g. query) number of the assessment. Therefore, the data plots of graph 1300 associated with each item position represent the posterior attribute probability for that data's corresponding attribute based on the queries and responses received to that point (item position). The vertical bars 1351 and 1352 represent the bootstrap SEE calculated for each of item positions 12 and 13, respectively. More specifically, the bootstrap SEE calculations for item positions 12 and 13 are 0.35 and 0.28, respectively.

However, unlike graphs 1100 and 1200, the example shown in graph 1300 does not use posterior probability as part of the termination rule. Instead, graph 1300 only uses the calculated bootstrap SEE as part of the termination rule, which are represented by vertical bars 1351 and 1352. The assessment represented by the content items shown in graph 1300 will be terminated after item position 13. The assessment will be terminated after item position 13 because from item position 12 to item position 13 the SEE drops from 0.35 and 0.28, and therefore drops below the 0.30 bootstrap SEE threshold.

FIG. 14 is a flow chart 1400 of an example process used to process content items and terminate an assessment based on a termination rule with sampling, according to embodiments of the present technology. Steps 1402 and 1404 in process 1400 are similar to steps 902 and 904 in process 900. The first step in the process is step 1402, which includes transmitting a query to a user as part of an assessment. In step 1404, a response to the query is received from the user to whom the query was sent. After the content items (queries and responses) have been collected, the process may proceed to step 1406.

In step 1406, the current length of the assessment (e.g. which item position in FIGS. 11-13) is analyzed to determine if the minimum assessment length has been met. If the minimum assessment length has not been met, then the process reverts back to step 1402 where another query is transmitted to the user. If, on the other hand, the minimum assessment length has been met, then the process proceeds to step 1408.

In step 1408, the posterior probability may be calculated based on the content items. As noted, the posterior probability may be calculated for one or multiple different attributes associated with the queries and responses, where the attributes may collectively make up a user profile associated with the user taking the assessment. In step 1410, the posterior probabilities may be analyzed to determine if the minimum posterior probability has been met. For example, the posterior probabilities of each attribute may be used to determine a combined posterior probability, such as a profile probability, which may represent the posterior probability for the content items as a whole. If the minimum posterior probability has not been met, then the process reverts back to step 1402, where another query may transmitted to the user and more content items will be collected for analysis. If, on the other hand, the minimum posterior probability has been met, then the process continues to step 1412.

In step 1412, sampling is performed on content items compiled based on queries sent to the user and responses received in response to the queries. As described further with respect to FIGS. 10-13, a termination rule with bootstrap sampling may be used. More specifically, an estimated error may be calculated by sampling data associated with content items to determine the stability of estimates of the posterior probability for attributes throughout a diagnostic assessment. In step 1414, an error calculation (e.g. SEE) may be determined that may be used as the termination rule, or as part of the termination rule.

In step 1416, a determination may be made of whether the error (e.g. SEE) meets a maximum error for termination. In other words, it may be determined whether the calculated error is lower than a predetermined threshold to confirm that termination is valid. If the maximum error for termination is not met, then the process may revert back to step 1402 for another query to be transmitted to the user to prompt a response to the new query and additional content data to be collected. If, on the other hand, the maximum error for termination is met, then the process proceeds to step 1418, where the assessment may be terminated.

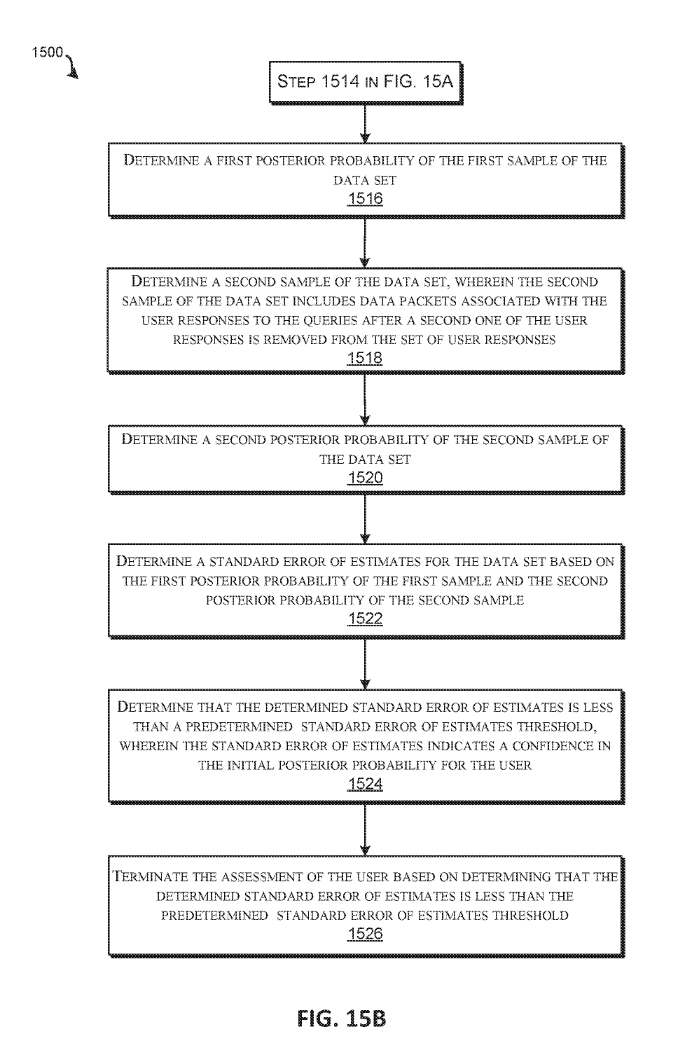

FIGS. 15A and 15B are a flow chart 1500 of an example process used to process content items and terminate an assessment based on a termination rule with sampling, according to embodiments of the present technology. Process 1500 begins at step 1502, which includes transmitting one or more queries to a user, wherein the queries are associated with an assessment of the user. Step 1504 includes receiving a data set including data packets associated with a set of user responses to the queries. Step 1506 includes determining an initial posterior probability based on the data set. Step 1508 includes determining that the initial posterior probability exceeds a predetermined threshold posterior probability. Step 1510 includes determining a current length of the assessment based on the one or more queries transmitted to the user. Step 1512 includes determining that the current length of the assessment exceeds a minimum assessment length. Step 1514 includes determining a first sample of the data set, wherein the first sample of the data set includes data packets associated with the user responses to the queries after a first one of the user responses is removed from the set of user responses, wherein determining the first sample of the data set is based on determining that the initial posterior probability exceeds a predetermined threshold posterior probability and that the current length of the assessment exceeds a minimum assessment length. Step 1516 includes determining a first posterior probability of the first sample of the data set. Step 1518 includes determining a second sample of the data set, wherein the second sample of the data set includes data packets associated with the user responses to the queries after a second one of the user responses is removed from the set of user responses. Step 1520 includes determining a second posterior probability of the second sample of the data set. Step 1522 includes determining a standard error of estimates for the data set based on the first posterior probability of the first sample and the second posterior probability of the second sample. Step 1524 includes determining that the determined standard error of estimates is less than a predetermined standard error of estimates threshold, wherein the standard error of estimates indicates a confidence in the initial posterior probability for the user. Step 1526 includes terminating the assessment of the user based on determining that the determined standard error of estimates is less than the predetermined standard error of estimates threshold.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

1. A computer-implemented method, comprising:
transmitting, by a server computer, one or more queries to a user, wherein the queries are associated with an assessment of the user;
receiving, at the server computer, a data set including data packets associated with a set of user responses to the queries;
determining an initial posterior probability based on the data set;
determining that the initial posterior probability exceeds a predetermined threshold posterior probability;
determining a current length of the assessment based on the one or more queries transmitted to the user;
determining that the current length of the assessment exceeds a minimum assessment length;
based on determining that the initial posterior probability exceeds a predetermined threshold posterior probability and that the current length of the assessment exceeds a minimum assessment length, determining a first sample of the data set, wherein the first sample of the data set includes data packets associated with the user responses to the queries after a first one of the user responses is removed from the set of user responses;
determining a first posterior probability of the first sample of the data set;
determining a second sample of the data set, wherein the second sample of the data set includes data packets associated with the user responses to the queries after a second one of the user responses is removed from the set of user responses;
determining a second posterior probability of the second sample of the data set;
determining a standard error of estimates for the data set based on the first posterior probability of the first sample and the second posterior probability of the second sample;
determining that the determined standard error of estimates is less than a predetermined standard error of estimates threshold, wherein the standard error of estimates indicates a confidence in the initial posterior probability for the user; and
terminating the assessment of the user based on determining that the determined standard error of estimates is less than the predetermined standard error of estimates threshold.

2. The method of claim 1, wherein the first one of the user responses removed from the set of user responses and the second one of the user responses removed from the set of user responses are different user responses.

3. The method of claim 1, wherein the first one of the user responses is replaced to the set of user responses before the second one of the user responses is removed from the set of user responses.

4. The method of claim 1, wherein terminating the assessment of the user includes determining a diagnostic classification model associated with the user based on the data set.

5. The method of claim 1, further comprising:
transmitting a communication to the user, wherein the communication includes an assessment score or an attribute status.

6. The method of claim 1, further comprising:
determining a maximum assessment length; and
determining that the current length of the assessment is less than the maximum assessment length;
wherein determining the first sample of the data set is also based on determining that the current length of the assessment is less than the maximum assessment length.

7. The method of claim 1, further comprising:
determining a profile probability, wherein the profile probability is determined based on the first posterior probability of the second sample of the data set and the second posterior probability of the second sample of the data set.

8. The method of claim 7, wherein the profile probability is a combined posterior probability associated with an attribute profile of the user.

9. A computing device, comprising:
one or more processors;
a wireless transceiver communicatively coupled to the one or more processors;
a non-transitory computer readable storage medium communicatively coupled to the one or more processors, wherein the non-transitory computer readable storage medium includes instructions that, when executed by the one or more processors, cause the one or more processors to perform operations including:
transmitting, by a server computer, one or more queries to a user, wherein the queries are associated with an assessment of the user;
receiving, at the server computer, a data set including data packets associated with a set of user responses to the queries;
determining an initial posterior probability based on the data set;
determining that the initial posterior probability exceeds a predetermined threshold posterior probability;
determining a current length of the assessment based on the one or more queries transmitted to the user;
determining that the current length of the assessment exceeds a minimum assessment length;
based on determining that the initial posterior probability exceeds a predetermined threshold posterior probability and that the current length of the assessment exceeds a minimum assessment length, determining a first sample of the data set, wherein the first sample of the data set includes data packets associated with the user responses to the queries after a first one of the user responses is removed from the set of user responses;
determining a first posterior probability of the first sample of the data set;
determining a second sample of the data set, wherein the second sample of the data set includes data packets associated with the user responses to the queries after a second one of the user responses is removed from the set of user responses;
determining a second posterior probability of the second sample of the data set;
determining a standard error of estimates for the data set based on the first posterior probability of the first sample and the second posterior probability of the second sample;
determining that the determined standard error of estimates is less than a predetermined standard error of estimates threshold, wherein the standard error of estimates indicates a confidence in the initial posterior probability for the user; and
terminating the assessment of the user based on determining that the determined standard error of estimates is less than the predetermined standard error of estimates threshold.

10. The computing device of claim 9, wherein the first one of the user responses removed from the set of user responses and the second one of the user responses removed from the set of user responses are different user responses.

11. The computing device of claim 9, wherein the first one of the user responses is replaced to the set of user responses before the second one of the user responses is removed from the set of user responses.

12. The computing device of claim 9, wherein terminating the assessment of the user includes determining a diagnostic classification model associated with the user based on the data set.

13. The computing device of claim 9, wherein the operations further include:
transmitting a communication to the user, wherein the communication includes an assessment score or an attribute status.

14. The computing device of claim 9, wherein the operations further include:
determining a maximum assessment length; and
determining that the current length of the assessment is less than the maximum assessment length;
wherein determining the first sample of the data set is also based on determining that the current length of the assessment is less than the maximum assessment length.

15. The computing device of claim 9, wherein the operations further include:
determining a profile probability, wherein the profile probability is determined based on the first posterior probability of the second sample of the data set and the second posterior probability of the second sample of the data set.

16. The computing device of claim 15, wherein the profile probability is a combined posterior probability associated with an attribute profile of the user.

17. A non-transitory computer readable medium comprising instructions that, when executed by one or more processors, cause the one or more processors to perform operations including:
transmitting, by a server computer, one or more queries to a user, wherein the queries are associated with an assessment of the user;
receiving, at the server computer, a data set including data packets associated with a set of user responses to the queries;
determining an initial posterior probability based on the data set;
determining that the initial posterior probability exceeds a predetermined threshold posterior probability;
determining a current length of the assessment based on the one or more queries transmitted to the user;
determining that the current length of the assessment exceeds a minimum assessment length;
based on determining that the initial posterior probability exceeds a predetermined threshold posterior probability and that the current length of the assessment exceeds a minimum assessment length, determining a first sample of the data set, wherein the first sample of the data set includes data packets associated with the user responses to the queries after a first one of the user responses is removed from the set of user responses;
determining a first posterior probability of the first sample of the data set;
determining a second sample of the data set, wherein the second sample of the data set includes data packets associated with the user responses to the queries after a second one of the user responses is removed from the set of user responses;
determining a second posterior probability of the second sample of the data set;
determining a standard error of estimates for the data set based on the first posterior probability of the first sample and the second posterior probability of the second sample;
determining that the determined standard error of estimates is less than a predetermined standard error of estimates threshold, wherein the standard error of estimates indicates a confidence in the initial posterior probability for the user; and
terminating the assessment of the user based on determining that the determined standard error of estimates is less than the predetermined standard error of estimates threshold.

18. The non-transitory computer readable medium of claim 17, wherein the first one of the user responses removed from the set of user responses and the second one of the user responses removed from the set of user responses are different user responses.

19. The non-transitory computer readable medium of claim 17, wherein the first one of the user responses is replaced to the set of user responses before the second one of the user responses is removed from the set of user responses.

20. The non-transitory computer readable medium of claim 17, wherein terminating the assessment of the user includes determining a diagnostic classification model associated with the user based on the data set.

21.-24. (canceled)
